(19) United States
(12) Patent Application Publication
(10) Pub. No.: US 2025/0314917 A1
(43) Pub. Date: Oct. 9, 2025

(54) SEMICONDUCTOR PHOTONICS DEVICES AND METHODS OF FORMATION

(71) Applicant: Taiwan Semiconductor Manufacturing Company, Ltd., Hsinchu (TW)

(72) Inventors: Yu-Jung HSU, Hsinchu City (TW); Chin-Ying TSAI, Hsinchu City (TW); Ren-Wei XIAO, Hsinchu City (TW); Chien-Ying WU, Hsinchu City (TW); Chia-Wen HSUEH, Hsinchu City (TW)

(21) Appl. No.: 18/626,948

(22) Filed: Apr. 4, 2024

(51) Int. Cl. G02F 1/01

(52) U.S. Cl. CPC G02F 1/0147; G02F 1/011

(57) ABSTRACT

A semiconductor photonics device includes an optical modulator structure and a modulator heater structure. The position of the modulator heater structure, the shape of the modulator heater structure, and/or the material(s) of the modulator heater structure are selected to increase the heating efficiency of the modulator heater structure.

### BACKGROUND

A semiconductor device may be configured to use optical signals for high speed and secure data transmission between integrated circuits and/or semiconductor dies of the semiconductor device. An optical signal may be transferred through a waveguide in the semiconductor device. The waveguide enables confinement of the optical signal, which may reduce optical loss and increase propagation efficiency for the optical signal. Data may be encoded into an optical signal by modulating light into optical pulses through an optical modulator. The optical pulses are then transferred to the waveguide for propagation to other regions of the semiconductor device.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram of an example of a photonic integrated circuit described herein.

FIGS. 2A and 2B are diagrams of examples of a photonic integrated circuit and an associated semiconductor photonics device in which the photonic integrated circuit may be included.

FIGS. 3A-3G are diagrams of an example of forming the semiconductor photonics device described herein.

FIGS. 4A and 4B are diagrams of examples of a photonic integrated circuit and an associated semiconductor photonics device in which the photonic integrated circuit may be included.

FIGS. 5A-5G are diagrams of an example of forming the semiconductor photonics device described herein.

FIGS. 6A and 6B are diagrams of examples of a photonic integrated circuit and an associated semiconductor photonics device in which the photonic integrated circuit may be included.

FIGS. 7A-7H are diagrams of an example of forming the semiconductor photonics device described herein.

FIGS. 8A and 8B are diagrams of examples of a photonic integrated circuit and an associated semiconductor photonics device in which the photonic integrated circuit may be included.

FIGS. 9A-9H are diagrams of an example of forming the semiconductor photonics device described herein.

FIGS. 10A and 10B are diagrams of examples of a photonic integrated circuit and an associated semiconductor photonics device in which the photonic integrated circuit may be included.

FIGS. 11A and 11B are diagrams of examples of a photonic integrated circuit and an associated semiconductor photonics device in which the photonic integrated circuit may be included.

FIGS. 12A-12C are diagrams of examples of a photonic integrated circuit and an associated semiconductor photonics device in which the photonic integrated circuit may be included.

FIGS. 13A-13H are diagrams of an example of forming the semiconductor photonics device described herein.

FIGS. 14A and 14B are diagrams of examples of a photonic integrated circuit and an associated semiconductor photonics device in which the photonic integrated circuit may be included.

FIGS. 15A-15C are diagrams of examples of a photonic integrated circuit and an associated semiconductor photonics device in which the photonic integrated circuit may be included.

FIGS. 16A and 16B are diagrams of examples of a photonic integrated circuit and an associated semiconductor photonics device in which the photonic integrated circuit may be included.

FIGS. 17A and 17B are diagrams of examples of a photonic integrated circuit and an associated semiconductor photonics device in which the photonic integrated circuit may be included.

FIG. 18 is a flowchart of an example process associated with forming a semiconductor photonics devices described herein.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

A photonic integrated circuit of a semiconductor photonics device may include a waveguide structure and an optical modulator structure. The waveguide structure and the optical modulator structure may be included in one or more dielectric layers of the semiconductor photonics device. The resonant wavelengths of the optical modulator structure may be sensitive to variations in processes and operating temperatures. To stabilize the resonant wavelengths of the optical modulator structure, a modulator heater structure may be located near the optical modulator structure to provide heat to the optical modulator structure. The heat provided by the modulator heater structure enables the operating temperature of the optical modulator structure to be maintained at a consistent operating temperature during operation of the semiconductor photonics device.

While some of the heat generated by the modulator heater structure is transferred to the optical modulator structure, the dielectric layer(s) surrounding the modulator heater structure also absorb heat generated by the modulator heater structure (e.g., heat that could otherwise be used to heat the optical modulator structure). This results in inefficient operation of the modulator heater structure in that a greater amount of heat needs to be generated in order to compensate for the heat loss due to the heat absorbed in the dielectric layer(s), thereby increasing the power consumption of the semiconductor photonics device.

In some implementations described herein, a semiconductor photonics device includes an optical modulator structure and a modulator heater structure. In some implementations, the modulator heater structure includes one or more heater sections that are located side by side with the optical modulator structure as opposed to (or in addition to) above and/or below the optical modulator structure. The horizontal arrangement of the optical modulator structure and the modulator heater structure enables the modulator heater structure to be positioned closer to the optical modulator structure, which enables more of the heat generated by the modulator heater structure to be provided to the optical modulator structure. The horizontal arrangement of the optical modulator structure and the modulator heater structure results in increased efficiency in the operation of the modulator heater structure in that less heat loss occurs due heat absorption in the dielectric layer(s) surrounding the optical modulator structure, thereby reducing the power consumption of the semiconductor photonics device.

Additionally and/or alternatively, in some implementations, a modulator heater structure described herein includes a top view shape and/or includes one or more materials that improve the heater efficiency of the modulator heater structure. Examples of such top view shapes include a coil shape, a square-wave shape, a rectangular-wave shape, and/or another type of top view shape that has a plurality of segments for increasing the surface area through which heat is radiated from the modulator heater structure. Examples of such materials include doped semiconductor materials, metal silicide materials, graphene, and/or p-type and n-type materials (e.g., for heating based on the thermoelectric effect), among other examples. The top view shapes and/or materials described herein enable the modulator heater structure to more efficiently heat an associated optical modulator structure for controlling the resonant wavelengths of the optical modulator structure, which reduces power consumption and increases power efficiency of a semiconductor photonics device in which the modulator heater structure is included.

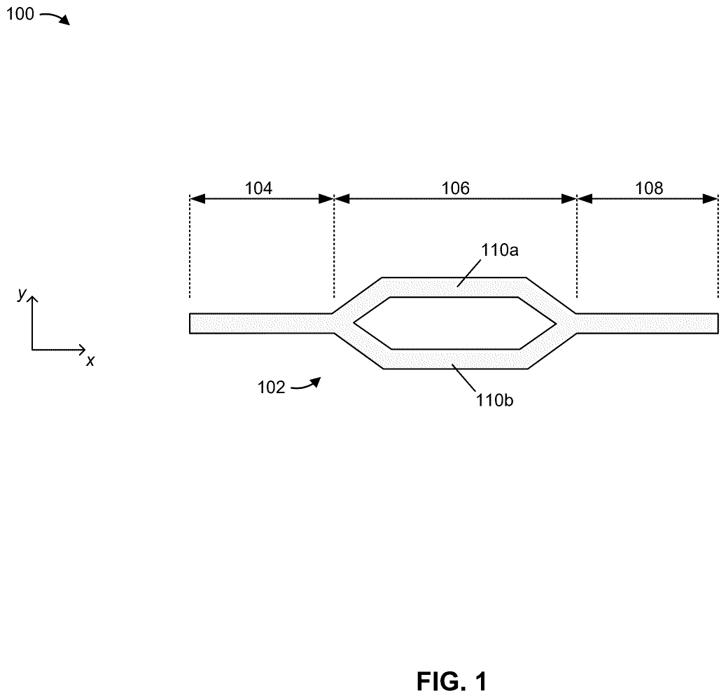

FIG. 1 is a diagram of an example 100 of a photonic integrated circuit 102 described herein. FIG. 1 illustrates a top view of the photonic integrated circuit 102. The photonic integrated circuit 102 includes a waveguide structure 104 optically and/or physically coupled with an optical modulator structure 106. The photonic integrated circuit 102 may also include another waveguide structure 108, where the waveguide structure 104 and the waveguide structure 108 are coupled with the optical modulator structure 106 at opposing ends of the optical modulator structure 106.

The photonic integrated circuit 102 may include a Mach-Zehnder modulator (MZM) structure or another type of optical modulator integrated circuit in which optical signals (e.g., input optical signals, modulated optical signals) are coupled between one or more waveguides (e.g., the waveguide structure 104 and/or the waveguide structure 108) and the optical modulator structure 106. The waveguide structure 104 may correspond to an input waveguide for providing optical signals to the optical modulator structure 106, and the waveguide structure 108 may correspond to an output waveguide for receiving modulated optical signals from the optical modulator structure 106. Thus, optical signals may propagate through the photonic integrated circuit 102 primarily in an x-direction indicated in FIG. 1.

The waveguide structures 104 and 108 may each include approximately straight- lined structures of silicon (Si), germanium (Ge), and/or another waveguide material through which optical signals may propagate. The waveguide structures 104 and 108 may each extend in the x-direction.

The optical modulator structure 106 may include a silicon (Si) or another type of semiconductor material, and may include a plurality of optical modulator segments 110a and 110b spaced apart from each other in a y-direction indicated in FIG. 1. Ends of the optical modulator segments 110a and 110b are coupled with the waveguide structure 104, and optical signals received from the waveguide structure 104 are split between the optical modulator segments 110a and 110b. This enables different voltage inputs to be applied to optical signals propagating through the optical modulator segments 110a and 110b. The optical modulator segments 110a and 110b may each include P-N (p-type/n-type) junctions that enable the voltage inputs to modify the refractive indices in the optical modulator segments 110a and 110b, thereby enabling the optical modulator structure 106 to modulate the optical signals propagating through the optical modulator segments 110a and 110b. The modulated optical signals may be combined and provided to the waveguide structure 108.

As indicated above, FIG. 1 is provided as an example. Other examples may differ from what is described with regard to FIG. 1.

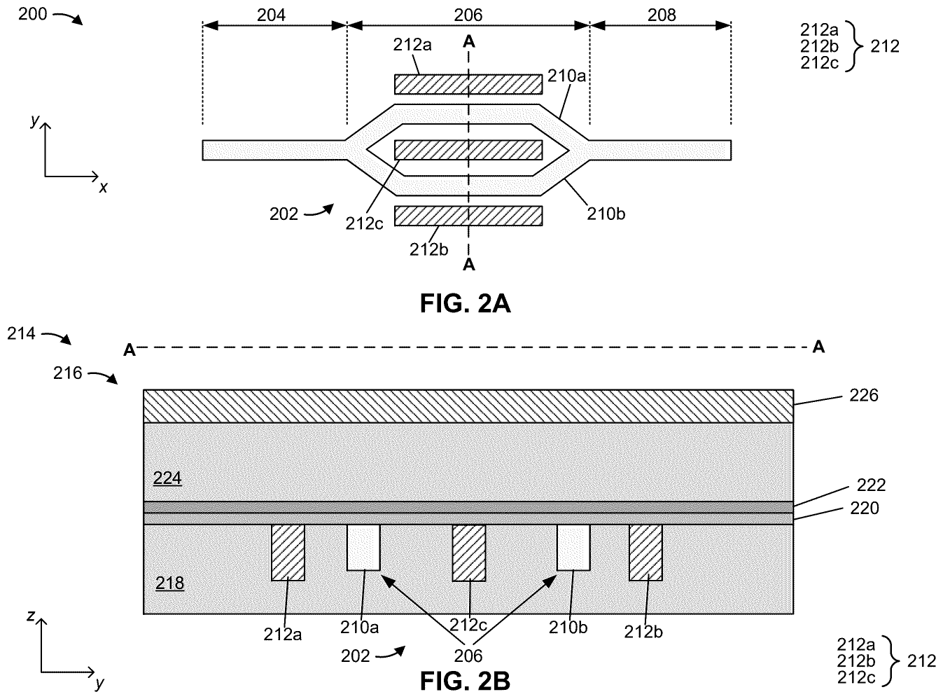

FIGS. 2A and 2B are diagrams of examples of a photonic integrated circuit and an associated semiconductor photonics device in which the photonic integrated circuit may be included. FIG. 2A illustrates a top view of an example 200 of a photonic integrated circuit 202. The photonic integrated circuit 202 is similar to the photonic integrated circuit 102 illustrated in FIG. 1, and includes a waveguide structure 204, an optical modulator structure 206, and a waveguide structure 208. The optical modulator structure 206 includes optical modulator segments 210a and 210b.

As further shown in FIG. 2A, the example 200 further includes a modulator heater structure 212 proximate to the optical modulator structure 206. The modulator heater structure 212 may be configured to provide heat to the optical modulator structure 206 to stabilize the operating temperature of the optical modulator structure 206, which enables the resonant wavelengths of the optical modulator structure 206 to be stabilized during operation of the optical modulator structure 206. The modulator heater structure 212 includes a plurality of heater sections 212a-212c, where each of the heater sections 212a-212c is located adjacent to at least one side of the optical modulator segments 210a and/or 210b of the optical modulator structure 206. For example, the heater section 212a may be located adjacent to (or side by side with) an outer side of the optical modulator segment 210a. As another example, the heater section 212b may be located adjacent to (or next to) an outer side of the optical modulator segment 210b. As another example, the heater section 212c may be located adjacent to (or side by side with) inner sides of the optical modulator segments 210a and 210b.

The heater sections 212a-212c may extend along the sides of the optical modulator segments 210a and 210b in the x-direction. An electrical input such as a voltage and/or electrical current may be provided to each of the heater sections 212a-212c, and the heater sections 212a-212c may dissipate the electrical input in the form of heat that is radiated from the heater sections 212a-212c toward the optical modulator segments 210a and 210b. The heater sections 212a-212c may include one or more materials that are capable of generating heat from an electrical input. In some implementations, the heater sections 212a-212c may each include one or more metals such as tungsten (W), copper (Cu), aluminum (Al), another metal, and/or an alloy thereof. In some implementations, the heater sections 212a-212c may include another material such as silicon (Si), silicon doped with one or more types of dopants (e.g., p-type dopants such as boron (B), aluminum (Al), and/or gallium (Ga), among other examples; n-type dopants such as phosphorous (P), arsenic (As), and/or antimony (Sb), among other examples), a metal silicide (e.g., tungsten silicide (WSi), titanium silicide (TiSi)), graphene, and/or barrier metals such as tantalum nitride (TaN) and/or titanium nitride (TiN), among other examples.

FIG. 2B illustrates an example 214 of a semiconductor photonics device 216 in which the photonics integrated circuit 202 and associated modulator heater structure 212 may be included. FIG. 2B illustrates a cross-section view along the line A-A in FIG. 2A. In particular, the cross-section view is across the optical modulator segments 210a and 210b and across the heater sections 212a-212c in the y-direction. Thus, FIG. 2B illustrates the cross-section view in a y-z plane in the semiconductor photonics device 216.

As shown in FIG. 2B, the semiconductor photonics device 216 may include a plurality of dielectric layers, including dielectric layers 218, 220, 222, and/or 224, among other examples. The dielectric layer 218 may be referred to as a shallow trench isolation (STI) layer, and may provide electrical isolation and/or optical isolation between the optical modulator segments 210a and 210b of the optical modulator structure 206, and/or between the optical modulator segments 210a and 210b and the heater sections 212a-212c, among other functions. The dielectric layers 220 and 222 may each include etch stop layers (ESLs), passivation layers, isolation layers, and/or other types of dielectric layers. The dielectric layer 224 may include an interlayer dielectric (ILD) layer in which one or more metallization layers may be formed. A metallization layer 226 may be included above the dielectric layer 224, and may be configured to provide electrical signals and/or power to and/or from the optical modulator structure 206 and/or the modulator heater structure 212, among other examples.

The dielectric layers 218, 220, 222, and/or 224 may include one or more dielectric materials, such as a silicon oxide (SiOx), a silicon nitride (SixNy), a silicon oxynitride (SiON), tetraethyl orthosilicate oxide, phosphosilicate glass (PSG), borophosphosilicate glass (BPSG), fluorinated silica glass (FSG), carbon doped silicon oxide, and/or another dielectric material. In some implementations, two or more of the dielectric layers 218, 220, 222, and/or 224 include the same dielectric material and/or the same composition of dielectric materials. In some implementations, two or more of the dielectric layers 218, 220, 222, and/or 224 include different dielectric materials and/or different compositions of dielectric materials.

The metallization layer 226 may include one or more electrically conductive metals, such as tungsten (W), cobalt (Co), ruthenium (Ru), titanium (Ti), aluminum (Al), copper (Cu) or gold (Au), among other examples. The metallization layer 226 may include one or more vias, one or more trenches, one or more contact plugs, one or more conductive traces, and/or other types of conductive structures.

As further shown in FIG. 2B, the optical modulator segments 210a and 210b and the heater sections 212a-212c are included in the dielectric layer 218. The heater sections 212a-212c are located laterally adjacent to the optical modulator segments 210a and 210b in the y-direction in the semiconductor photonics device 216, as opposed to being located above the optical modulator segments 210a and 210b in the dielectric layer 224. This enables the heater sections 212a-212c to directly radiate heat laterally toward the optical modulator segments 210a and 210b in the dielectric layer 218, as opposed to vertically radiating heat toward the optical modulator segments 210a and 210b through the dielectric layers 220, 222, and 224. This may improve the heating efficiency of the modulator heater structure 212.

The top surfaces of the optical modulator segments 210a and 210b and the heater sections 212a-212c may be co-planar in the dielectric layer 218. In some implementations, the bottom surfaces of the optical modulator segments 210a and 210b and the heater sections 212a-212c may be co-planar in the dielectric layer 218. In some implementations, the bottom surfaces of the heater sections 212a-212c are located at a lower position in the z-direction in the semiconductor photonics device 216 than the bottom surfaces of the optical modulator segments 210a and 210b. In some implementations, the bottom surfaces of the optical modulator segments 210a and 210b are located at a lower position in the z-direction in the semiconductor photonics device 216 than the bottom surfaces of the heater sections 212a-212c.

As indicated above, FIGS. 2A and 2B are provided as examples. Other examples may differ from what is described with regard to FIGS. 2A and 2B.

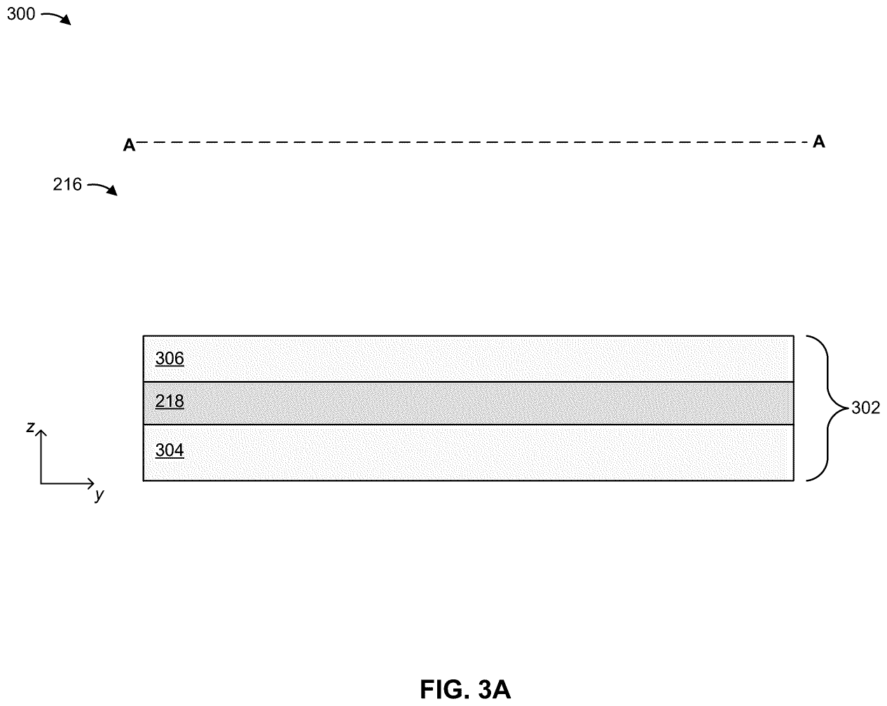

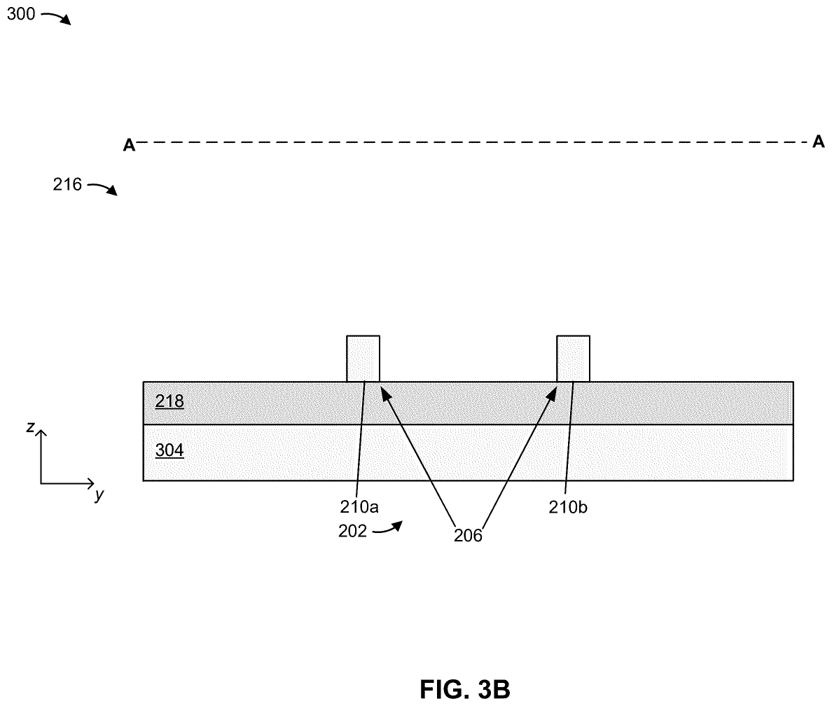

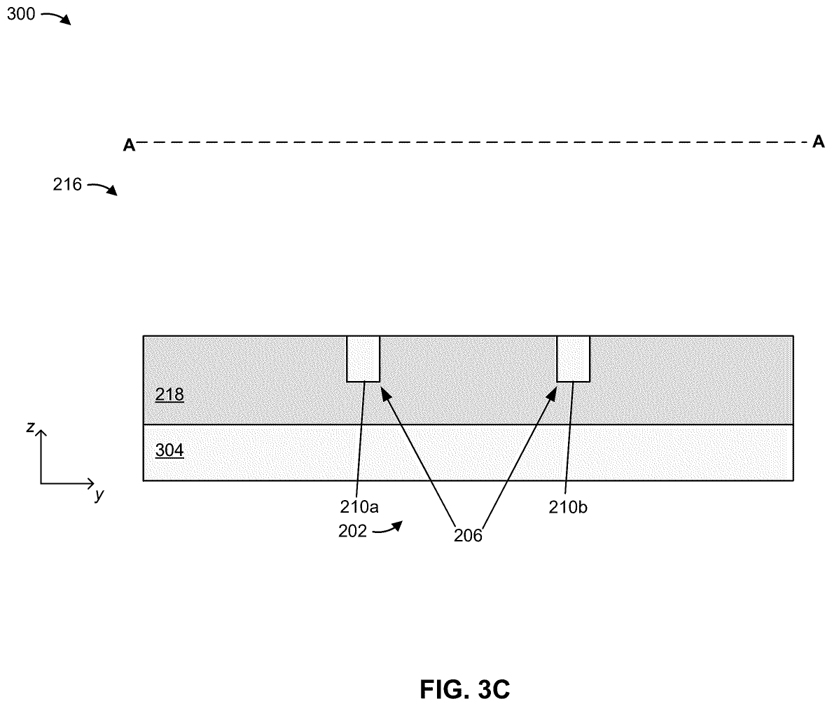

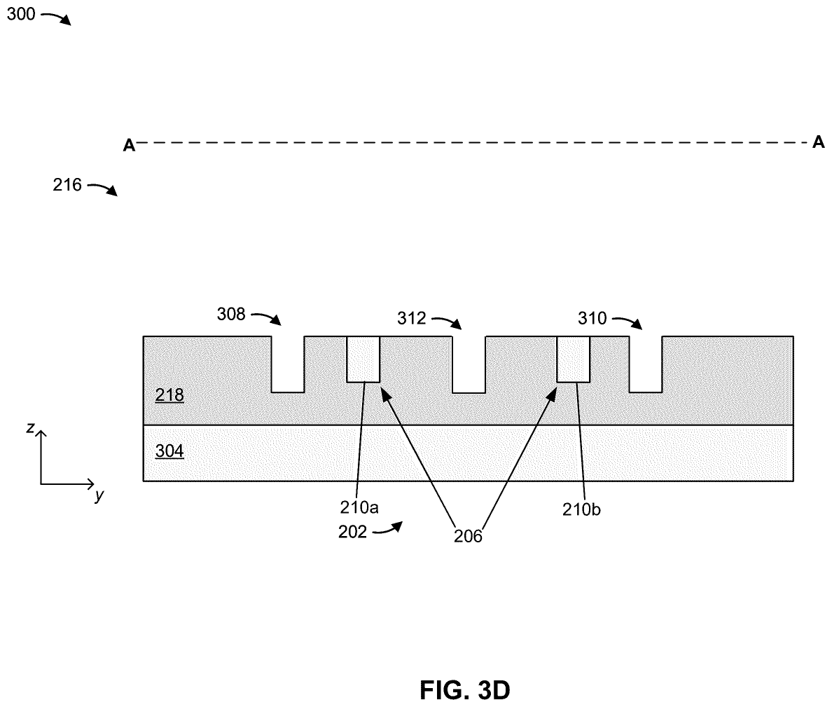

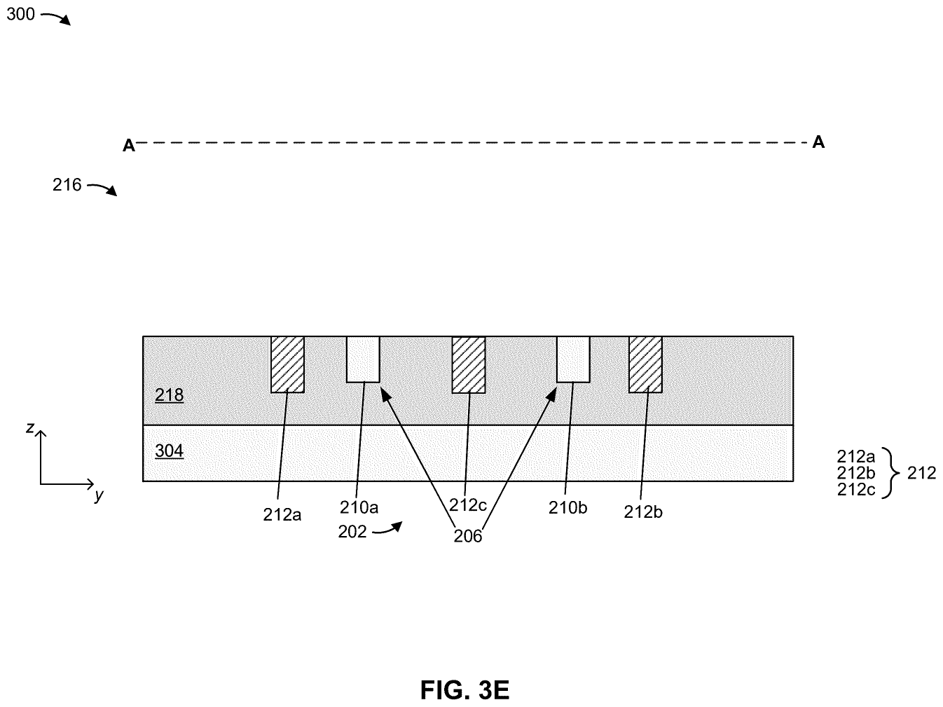

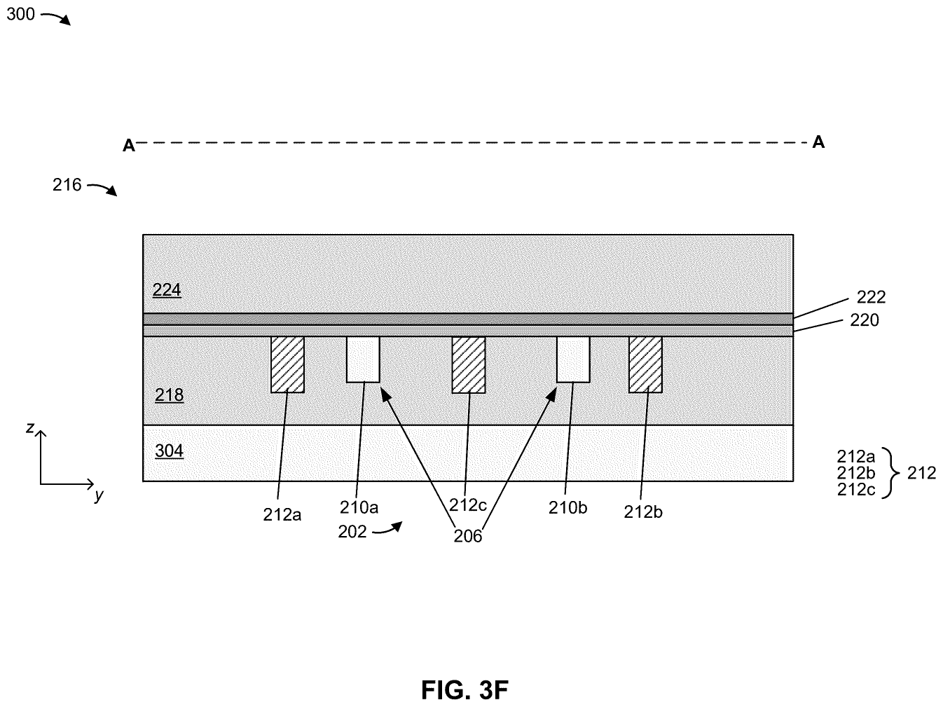

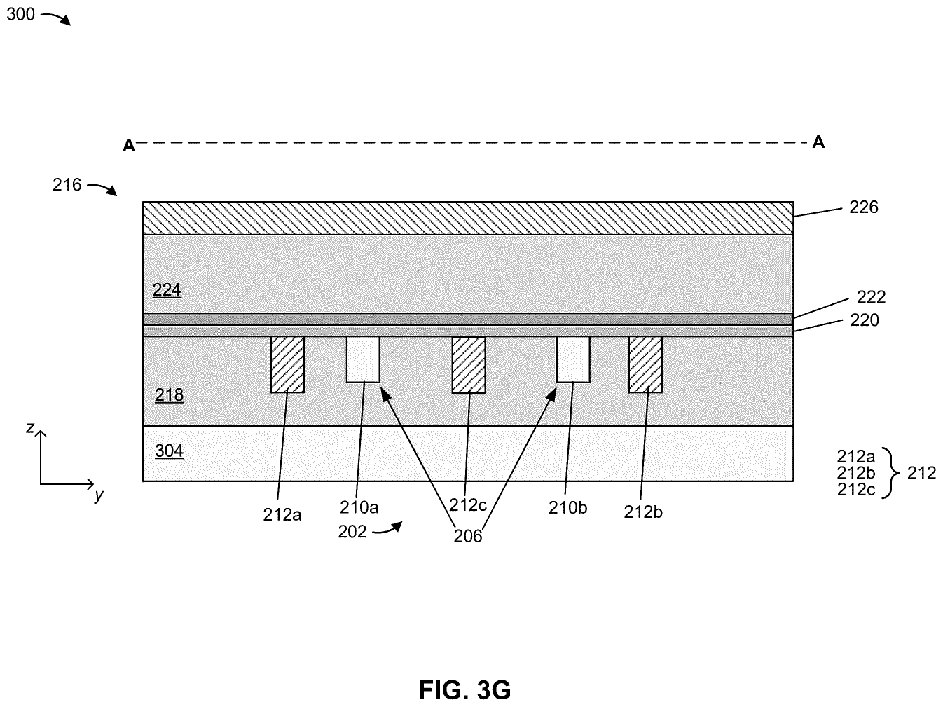

FIGS. 3A-3G are diagrams of an example 300 of forming the semiconductor photonics device 216 described herein. In particular, the example 300 includes an example of forming the photonic integrated circuit 202 and the associated modulator heater structure 212 in the semiconductor photonics device 216. In some implementations, one or more of the semiconductor processing operations described in connection with FIGS. 3A-3G are performed using one or more semiconductor processing tools, such as a deposition tool, an exposure tool, a developer tool, an etch tool, a plating tool, a planarization tool, an ion implantation tool, a wafer/die transport tool, and/or another type of semiconductor processing tool.

Turning to FIG. 3A, a substrate 302 may be provided. The substrate 302 may include a silicon on insulator (SOI) substrate that includes a semiconductor substrate 304 (e.g., a silicon (Si) substrate and/or another type of semiconductor substrate), a portion of the dielectric layer 218 (e.g., a buried oxide or bottom oxide (BOX) layer and/or another type of insulator layer) over and/or on the semiconductor substrate 304, and a semiconductor layer 306 (e.g., a silicon (Si) layer and/or another type of semiconductor layer) over and/or on the portion of the dielectric layer 218. Alternatively, the semiconductor substrate 304 may be provided as a semiconductor wafer, and a deposition tool may be used to form the portion of the dielectric layer 218 over and/or on the semiconductor substrate 304, and may form the semiconductor layer 306 over and/or on the portion of the dielectric layer 218. A deposition tool may be used to deposit the portion of the dielectric layer 218 using a chemical vapor deposition (CVD) technique, a physical vapor deposition (PVD) technique, an oxidation technique (e.g., a thermal oxidation technique), and/or another type of deposition technique. A deposition tool may be used to form the semiconductor layer 306 using an epitaxy technique and/or another type of deposition technique.

As shown in FIG. 3B, the optical modulator structure 206 (including the optical modulator segments 210a and 210b) may be formed in the semiconductor layer 306 such that the optical modulator structure 206 is located above the portion of the dielectric layer 218. The waveguide structures 204 and 208 (not shown in the cross-section view along the line A-A) may also be formed in the semiconductor layer 306 above the portion of the dielectric layer 218 along with the optical modulator structure 206.

In some implementations, a hard mask layer may be formed over and/or on the semiconductor layer 306, and a pattern in the hard mask layer may be used to etch the semiconductor layer 306 to form the optical modulator structure 206 (and the waveguide structures 204 and 208). Deposition tools may be used to deposit the hard mask layer on the semiconductor layer 306 (e.g., using a CVD technique, a PVD technique, and/or another type of deposition technique) and a photoresist layer on the hard mask layer (e.g., using a spin-coating technique and/or another type of deposition technique). The hard mask layer may include a silicon nitride (SiₓN_{y} such as Si₃N₄) material or another hard mask material. The photoresist layer may include a light-sensitive material that can be patterned using an exposure tool such as a deep ultraviolet (DUV) lithography tool and/or an extreme ultraviolet (EUV) lithography tool, among other examples.

An exposure tool may be used to expose the photoresist layer to a radiation source to form a pattern in the photoresist layer. A developer tool may be used to develop and remove portions of the photoresist layer to expose the pattern. An etch tool may be used to etch the hard mask layer to transfer the pattern from the photoresist layer to the hard mask layer. An etch tool may then be used to etch the semiconductor layer 306 based on the pattern in the hard mask layer to remove material from the semiconductor layer 306 to form the optical modulator structure 206 (and the waveguide structures 204 and 208). In some implementations, the etch operation includes a plasma etch operation, a wet chemical etch operation, and/or another type of etch operation. In some implementations, a photoresist removal tool removes the remaining portions of the photoresist layer (e.g., using a chemical stripper, plasma ashing, and/or another technique).

As shown in FIG. 3C, additional material of the dielectric layer 218 may be deposited around the optical modulator structure 206 (and the waveguide structures 204 and 208) using a CVD technique, a PVD technique, an oxidation technique, and/or another type of deposition technique. In some implementations, the additional material of the dielectric layer 218 is also deposited on the optical modulator structure 206 (and the waveguide structures 204 and 208), and a planarization tool is used to perform a planarization operation (e.g., a chemical mechanical polishing/planarization (CMP) operation) to planarize the dielectric layer 218 such that the top surface of the dielectric layer 218 and the top surfaces of the optical modulator structure 206 (and the waveguide structures 204 and 208) are approximately co-planar.

As shown in FIG. 3D, recesses 308, 310, and 312 are formed in the dielectric layer 218 next to the optical modulator segments 210a and 210b of the optical modulator structure 206. For example, the recess 308 may be formed adjacent to an outer side of the optical modulator segment 210a in the dielectric layer 218. As another example, the recess 310 may be formed adjacent to an outer side of the optical modulator segment 210b in the dielectric layer 218. As another example, the recess 312 may be formed adjacent to inner sides of the optical modulator segments 210a and 210b in the dielectric layer 218.

In some implementations, a pattern in a photoresist layer is used to etch the dielectric layer 218 to form the recesses 308, 310, and/or 312. In these implementations, a deposition tool may be used to form the photoresist layer on the dielectric layer 218. An exposure tool may be used to expose the photoresist layer to a radiation source to pattern the photoresist layer. A developer tool may be used to develop and remove portions of the photoresist layer to expose the pattern. An etch tool may be used to etch the dielectric layer 218 based on the pattern to form the recesses 308, 310, and/or 312 in the dielectric layer 218. In some implementations, the etch operation includes a plasma etch operation, a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the dielectric layer 218 based on a pattern.

In some implementations, the bottom surfaces of the recesses 308, 310, and/or 312 are approximately co-planar with the bottom surfaces of the optical modulator segments 210a and/or 210b. In some implementations, the bottom surfaces of the recesses 308, 310, and/or 312 are lower in the z-direction in the semiconductor photonics device 216 than the bottom surfaces of the optical modulator segments 210a and/or 210b. In some implementations, the bottom surfaces of the recesses 308, 310, and/or 312 are higher in the z-direction in the semiconductor photonics device 216 than the bottom surfaces of the optical modulator segments 210a and/or 210b.

As shown in FIG. 3E, the modulator heater structure 212 is formed in the recesses 308, 310, and/or 312 such that the modulator heater structure 212 is formed laterally adjacent to (or side by side with) the optical modulator structure 206 in the dielectric layer 218. The heater section 212a of the modulator heater structure 212 may be formed in the recess 308 such that the heater section 212a is located laterally adjacent to the outer side of the optical modulator segment 210a in the dielectric layer 218. The heater section 212b of the modulator heater structure 212 may be formed in the recess 310 such that the heater section 212b is located laterally adjacent to the outer side of the optical modulator segment 210b in the dielectric layer 218. The heater section 212c of the modulator heater structure 212 may be formed in the recess 312 such that the heater section 212c is located laterally adjacent to the inner sides of the optical modulator segments 210a and 210b in the dielectric layer 218.

A deposition tool and/or a plating tool may be used to deposit the heater sections 212a-212c of the modulator heater structure 212 using a CVD technique, a PVD technique, an atomic layer deposition (ALD) technique, an electroplating technique, and/or another suitable deposition technique. The heater sections 212a-212c of the modulator heater structure 212 may be deposited in one or more deposition operations. In some implementations, a seed layer is first deposited, and the heater sections 212a-212c of the modulator heater structure 212 are deposited on the seed layer. In some implementations, a planarization tool may be used to planarize the heater sections 212a-212c of the modulator heater structure 212 after the heater sections 212a-212c of the modulator heater structure 212 are deposited.

As shown in FIG. 3F, the dielectric layer 220 may be formed over and/or on the dielectric layer 218. The dielectric layer 220 is also formed over and/or on the optical modulator segments 210a and 210b of the optical modulator structure 206, and over and/or on the heater sections 212a-212c of the modulator heater structure 212. The dielectric layer 222 may be formed over and/or on the dielectric layer 220. The dielectric layer 224 may be formed over and/or on the dielectric layer 222.

A deposition tool may be used to deposit the dielectric layers 220, 222, and/or 224 using a CVD technique, a PVD technique, an ALD technique, an oxidation technique, and/or another suitable deposition technique. Each of the dielectric layers 220, 222, and/or 224 may be deposited in one or more deposition operations. In some implementations, a planarization tool may be used to planarize the dielectric layers 220, 222, and/or 224 after the dielectric layers 220, 222, and/or 224 are deposited.

As shown in FIG. 3G, a metallization layer 226 may be formed above the dielectric layer 224. Additionally and/or alternatively, the metallization layer 226 may be formed in a recess in the dielectric layer 224. In some implementations, one or more metallization layers (not shown in the cross-section view along the line A-A) are also formed in the dielectric layer 224 as contacts for the optical modulator structure 206 and/or as contacts for the modulator heater structure 212. A deposition tool and/or a plating tool may be used to deposit the metallization layer 226 using a CVD technique, a PVD technique, an ALD technique, an electroplating technique, and/or another suitable deposition technique. The metallization layer 226 may be deposited in one or more deposition operations. In some implementations, a seed layer is first deposited, and the metallization layer 226 is deposited on the seed layer. In some implementations, a planarization tool may be used to planarize the metallization layer 226 after the metallization layer 226 is deposited.

As indicated above, FIGS. 3A-3G are provided as an example. Other examples may differ from what is described with regard to FIGS. 3A-3G.

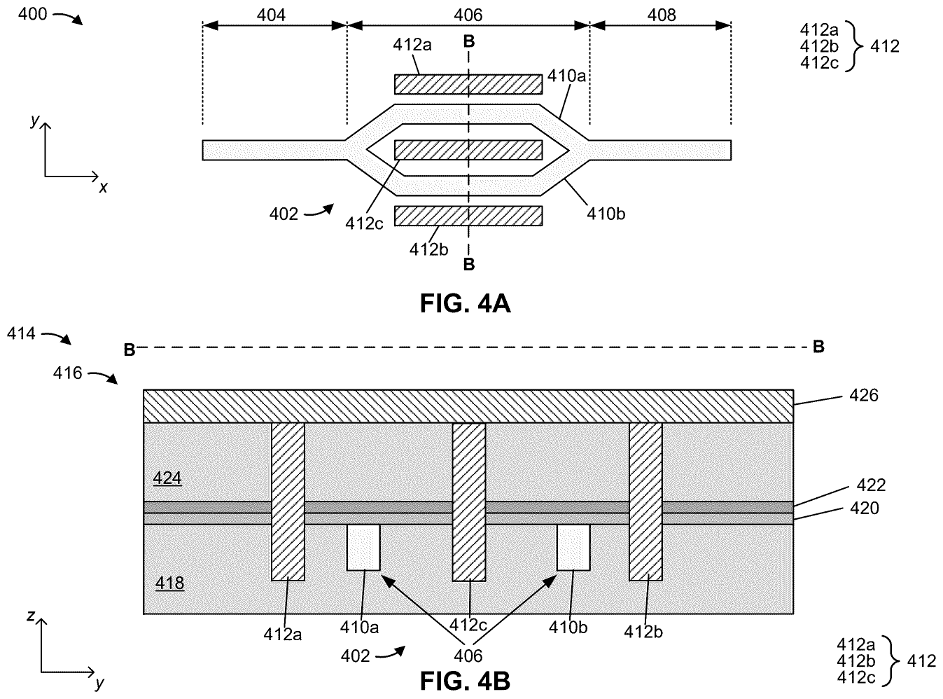

FIGS. 4A and 4B are diagrams of examples of a photonic integrated circuit and an associated semiconductor photonics device in which the photonic integrated circuit may be included. FIG. 4A illustrates a top view of an example 400 of a photonic integrated circuit 402. The photonic integrated circuit 402 is similar to the photonic integrated circuit 102 illustrated in FIG. 1, and includes a waveguide structure 404, an optical modulator structure 406, and a waveguide structure 408. The optical modulator structure 406 includes optical modulator segments 410a and 410b. As further shown in FIG. 4A, the example 400 further includes a modulator heater structure 412 proximate to the optical modulator structure 406. The modulator heater structure 412 includes a plurality of heater sections 412a-412c that are arranged in a similar top view configuration as the heater sections 212a-212c.

FIG. 4B illustrates an example 414 of a semiconductor photonics device 416 in which the photonics integrated circuit 402 and the associated modulator heater structure 412 may be included. FIG. 4B illustrates a cross-section view along the line B-B in FIG. 4A. In particular, the cross-section view is across the optical modulator segments 410a and 410b and across the heater sections 412a-412c in the y-direction. Thus, FIG. 4B illustrates the cross-section view in a y-z plane in the semiconductor photonics device 416.

As shown in FIG. 4B, the semiconductor photonics device 416 is similar to the semiconductor photonics device 216 and includes dielectric layers 418, 420, 422, and/or 424, and a metallization layer 426. Moreover, the optical modulator segments 410a and 410b and the heater sections 412a-412c are arranged in a similar manner in the semiconductor photonics device 416 as the optical modulator segments 210a and 210b and the heater sections 212a-212c in the semiconductor photonics device 216, except that the heater sections 412a-412c extend through the dielectric layers 420, 422, and 424 in the z-direction to the metallization layer 426. This enables the formation of the heater sections 412a-412c to be combined with formation of electrical contacts (e.g., electrical contacts for the photonic integrated circuit 402) in the semiconductor photonics device 416, which reduces the manufacturing cost, time, and/or complexity for forming the semiconductor photonics device 416.

As indicated above, FIGS. 4A and 4B are provided as examples. Other examples may differ from what is described with regard to FIGS. 4A and 4B.

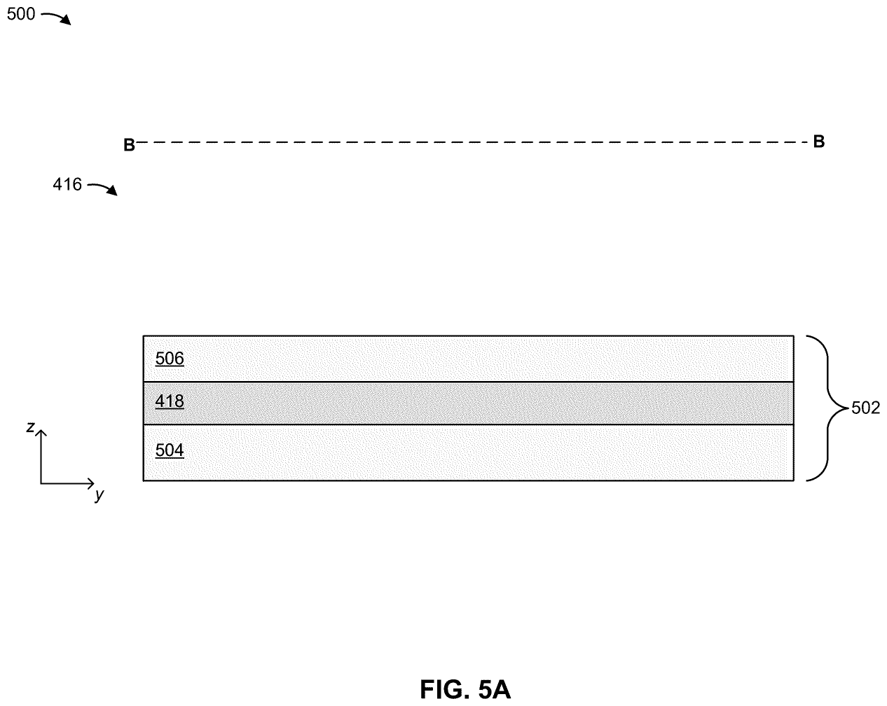

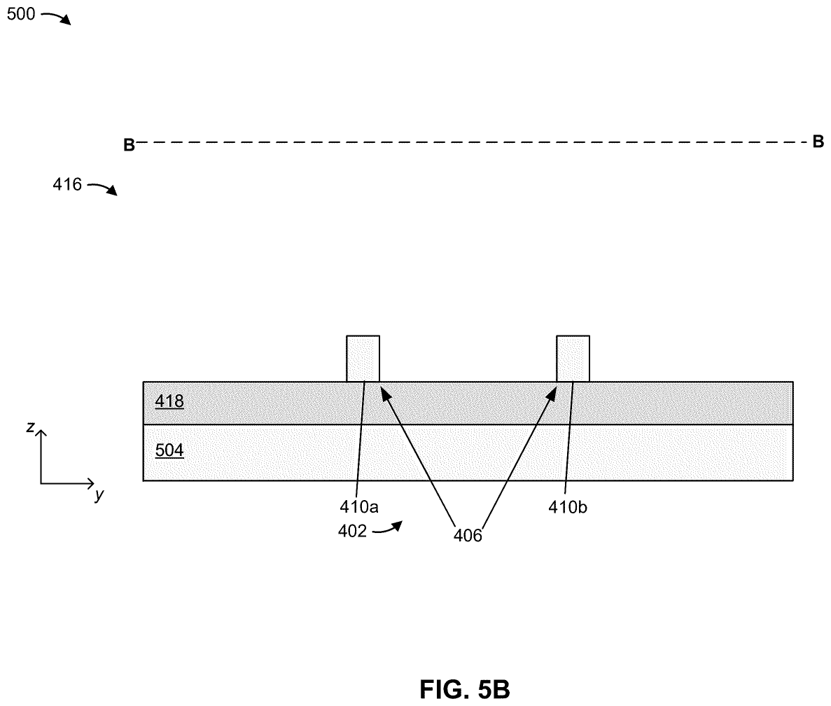

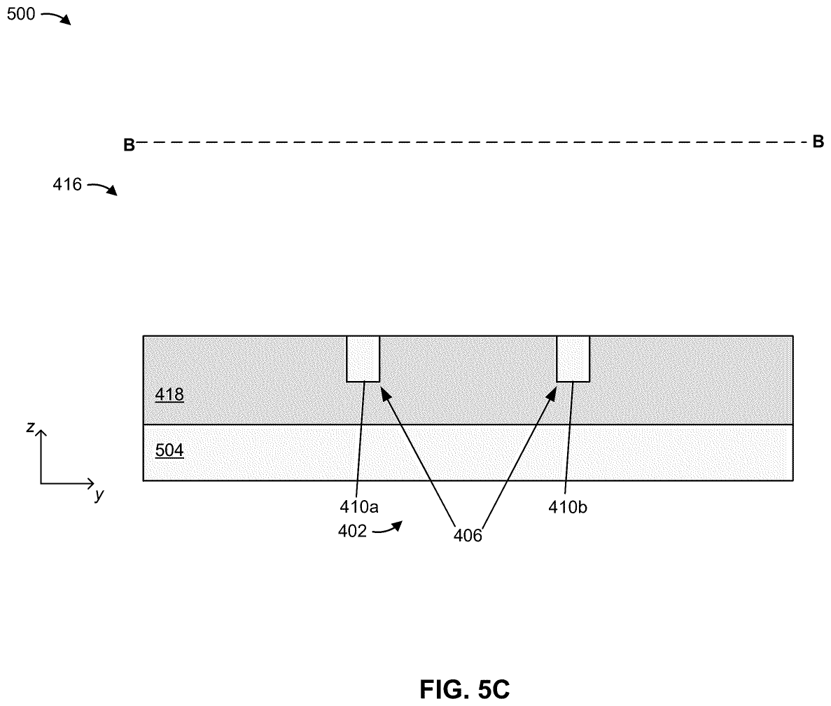

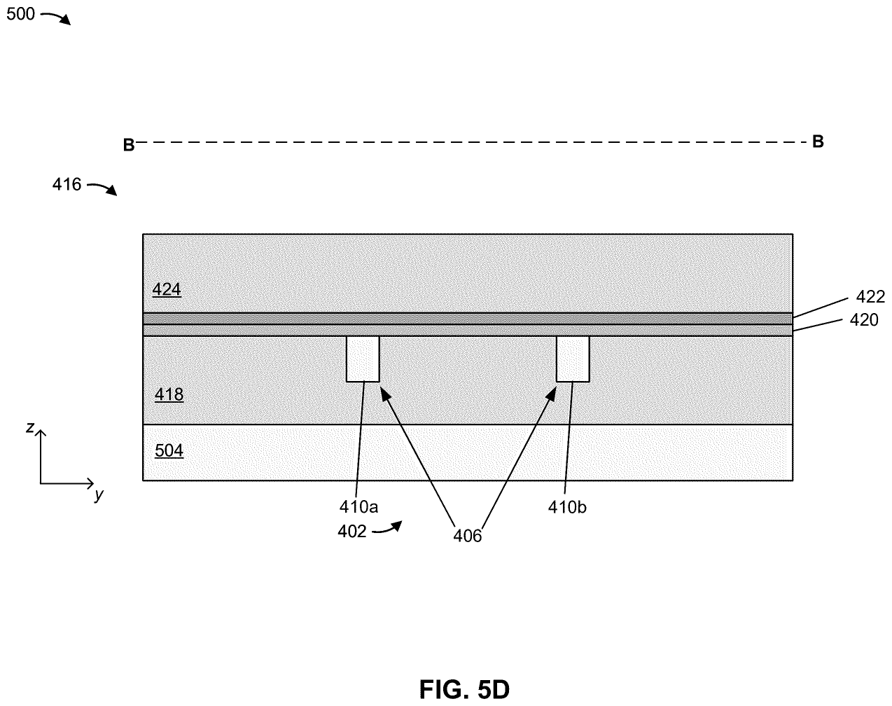

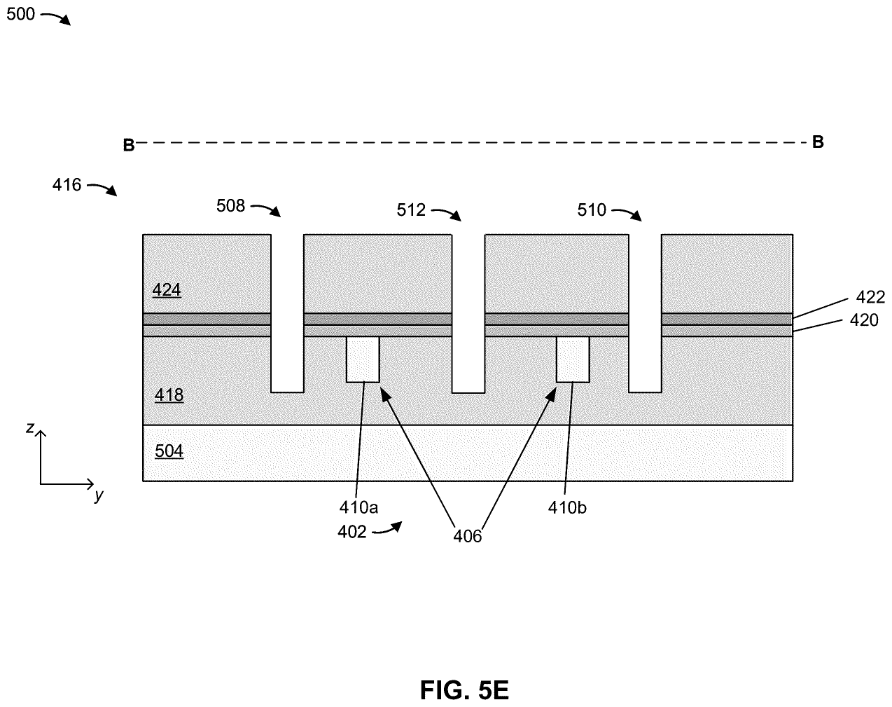

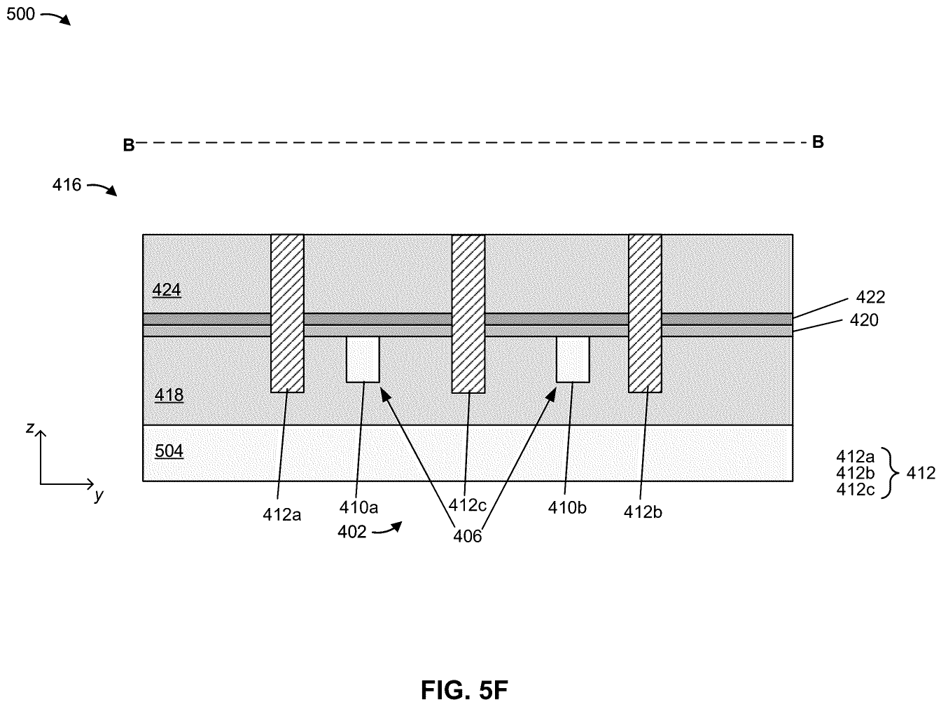

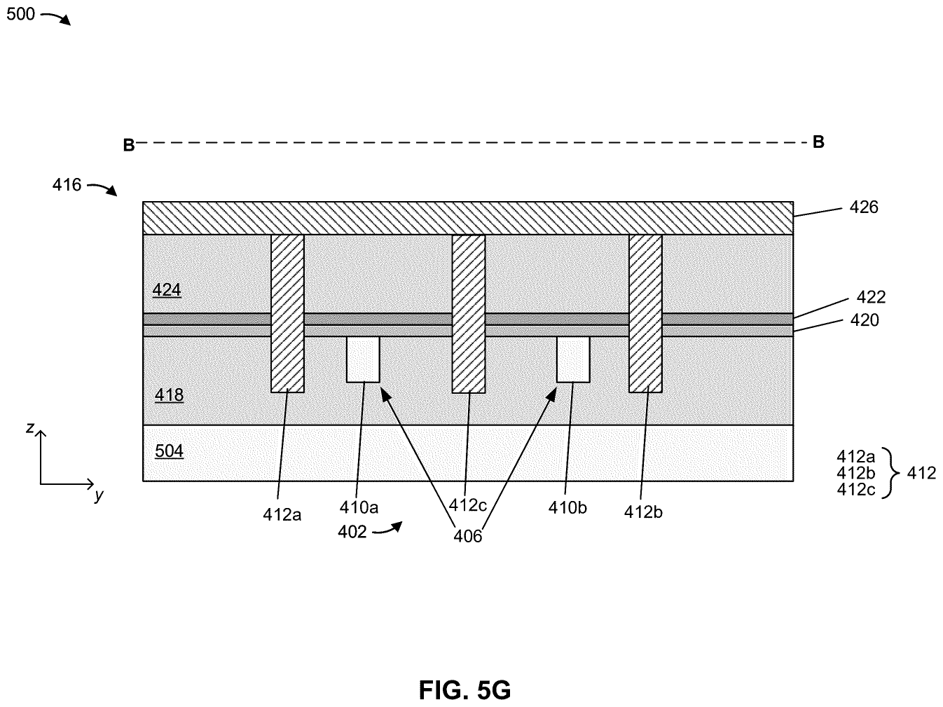

FIGS. 5A-5G are diagrams of an example 500 of forming the semiconductor photonics device 416 described herein. In particular, the example 500 includes an example of forming the photonic integrated circuit 402 and the associated modulator heater structure 412 in the semiconductor photonics device 416. In some implementations, one or more of the semiconductor processing operations described in connection with FIGS. 5A-5G are performed using one or more semiconductor processing tools, such as a deposition tool, an exposure tool, a developer tool, an etch tool, a plating tool, a planarization tool, an ion implantation tool, a wafer/die transport tool, and/or another type of semiconductor processing tool.

Turning to FIG. 5A, a substrate 502 may be provided. The substrate 502 may include an SOI substrate that includes a semiconductor substrate 504, a portion of the dielectric layer 418 over and/or on the semiconductor substrate 504, and a semiconductor layer 506 over and/or on the portion of the dielectric layer 418. Alternatively, the semiconductor substrate 504 may be provided as a semiconductor wafer, and a deposition tool may be used to form the portion of the dielectric layer 418 over and/or on the semiconductor substrate 504, and may form the semiconductor layer 506 over and/or on the portion of the dielectric layer 418.

As shown in FIGS. 5B and 5C, the optical modulator structure 406 (including the optical modulator segments 410a and 410b) may be formed in the semiconductor layer 506 such that the optical modulator structure 406 is located above the portion of the dielectric layer 418. The waveguide structures 404 and 408 (not shown in the cross-section view along the line B-B) may also be formed in the semiconductor layer 506 above the portion of the dielectric layer 418 along with the optical modulator structure 406. Additional material of the dielectric layer 418 may be deposited around the optical modulator structure 406 (and the waveguide structures 404 and 408). Similar process operations and/or techniques described in connection with FIGS. 3B and 3C may be used to form the optical modulator structure 406 and the additional material of the dielectric layer 418.

As shown in FIG. 5D, the dielectric layer 420 may be formed over and/or on the dielectric layer 418, the dielectric layer 422 may be formed over and/or on the dielectric layer 420, and the dielectric layer 424 may be formed over and/or on the dielectric layer 422 in a similar manner as described in connection with FIG. 3F. However, the dielectric layer 420 is formed over and/or on the optical modulator segments 410a and 410b of the optical modulator structure 406 prior to formation of the heater sections 412a-412c of the modulator heater structure 412. This is because the heater sections 412a-412c of the modulator heater structure 412 are formed as part of the contact formation process for the semiconductor photonics device 416.

As shown in FIGS. 5E and 5F, the contact formation process may be performed to form the heater sections 412a-412c of the modulator heater structure 412 along with contacts (not shown in the cross-section view along the line B-B) for the photonic integrated circuit 402. The heater sections 412a-412c may also function as the contacts for the modulator heater structure 412.

As shown in FIG. 5E, the contact formation process may include forming recesses 508, 510, and 512 through the dielectric layer 424, through the dielectric layer 422, through the dielectric layer 420, and into a portion of in the dielectric layer 418 next to the optical modulator segments 410a and 410b of the optical modulator structure 406. For example, the recess 508 may be formed adjacent to an outer side of the optical modulator segment 410a in the dielectric layer 418. As another example, the recess 510 may be formed adjacent to an outer side of the optical modulator segment 410b in the dielectric layer 418. As another example, the recess 512 may be formed adjacent to inner sides of the optical modulator segments 410a and 410b in the dielectric layer 418.

In some implementations, a pattern in a photoresist layer is used to etch the dielectric layers 418, 420, 422, and/or 424 to form the recesses 508, 510, and/or 512. In these implementations, a deposition tool may be used to form the photoresist layer on the dielectric layer 424. An exposure tool may be used to expose the photoresist layer to a radiation source to pattern the photoresist layer. A developer tool may be used to develop and remove portions of the photoresist layer to expose the pattern. An etch tool may be used to etch the dielectric layers 418, 420, 422, and/or 424 based on the pattern to form the recesses 508, 510, and/or 512. In some implementations, the etch operation includes a plasma etch operation, a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for forming the recesses 508, 510, and/or 512 based on a pattern.

In some implementations, the bottom surfaces of the recesses 508, 510, and/or 512 are approximately co-planar with the bottom surfaces of the optical modulator segments 410a and/or 410b. In some implementations, the bottom surfaces of the recesses 508, 510, and/or 512 are lower in the z-direction in the semiconductor photonics device 416 than the bottom surfaces of the optical modulator segments 410a and/or 410b. In some implementations, the bottom surfaces of the recesses 508, 510, and/or 512 are higher in the z-direction in the semiconductor photonics device 416 than the bottom surfaces of the optical modulator segments 410a and/or 410b.

As shown in FIG. 5F, the modulator heater structure 412 is formed in the recesses 508, 510, and/or 512 such that the modulator heater structure 412 extends through the dielectric layers 420, 422, and 424, and into the dielectric layer 418. The heater section 412a of the modulator heater structure 412 may be formed in the recess 508 such that the heater section 412a is located laterally adjacent to the outer side of the optical modulator segment 410a in the dielectric layer 418. The heater section 412b of the modulator heater structure 412 may be formed in the recess 510 such that the heater section 412b is located laterally adjacent to the outer side of the optical modulator segment 410b in the dielectric layer 418. The heater section 412c of the modulator heater structure 412 may be formed in the recess 512 such that the heater section 412c is located laterally adjacent to the inner sides of the optical modulator segments 410a and 410b in the dielectric layer 418.

As shown in FIG. 5G, a metallization layer 426 may be formed above the dielectric layer 424. Additionally and/or alternatively, the metallization layer 426 may be formed in a recess in the dielectric layer 424. Portions of the metallization layer 426 may be formed on the heater sections 412a-412c of the modulator heater structure 412 such that the heater sections 412a-412c of the modulator heater structure 412 are electrically coupled and/or physically coupled with the metallization layer 426. The metallization layer 426 may be formed in a similar manner as the metallization layer 226 as described above in connection with FIG. 3G.

As indicated above, FIGS. 5A-5G are provided as an example. Other examples may differ from what is described with regard to FIGS. 5A-5G.

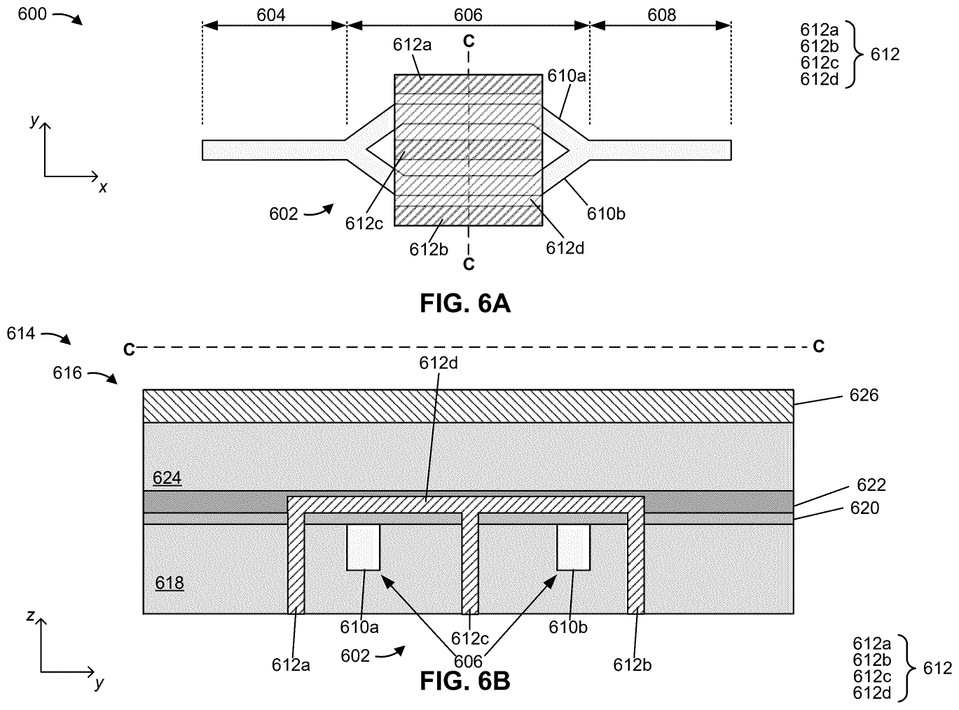

FIGS. 6A and 6B are diagrams of examples of a photonic integrated circuit and an associated semiconductor photonics device in which the photonic integrated circuit may be included. FIG. 6A illustrates a top view of an example 600 of a photonic integrated circuit 602. The photonic integrated circuit 602 is similar to the photonic integrated circuit 102 illustrated in FIG. 1, and includes a waveguide structure 604, an optical modulator structure 606, and a waveguide structure 608. The optical modulator structure 606 includes optical modulator segments 610a and 610b.

As further shown in FIG. 6A, the example 600 further includes a modulator heater structure 612 proximate to the optical modulator structure 606. The modulator heater structure 612 includes a plurality of heater sections 612a-612c that are arranged in a similar top view configuration as the heater sections 212a-212c. However, the modulator heater structure 612 further includes a connecting heater section 612d above the heater sections 612a-612c. The connecting heater section 612d extends in the y-direction across the optical modulator segments 610a and 610b and across the heater sections 612a-612c. The connecting heater section 612d connects the heater sections 612a-612c to form a continuous structure of the modulator heater structure 612.

FIG. 6B illustrates an example 614 of a semiconductor photonics device 616 in which the photonics integrated circuit 602 and the associated modulator heater structure 612 may be included. FIG. 6B illustrates a cross-section view along the line C-C in FIG. 6A. In particular, the cross-section view is across the optical modulator segments 610a and 610b and across the heater sections 612a-612c in the y-direction. Thus, FIG. 6B illustrates the cross-section view in a y-z plane in the semiconductor photonics device 616.

As shown in FIG. 6B, the semiconductor photonics device 616 is similar to the semiconductor photonics device 216 and includes dielectric layers 618, 620, 622, and/or 624, and a metallization layer 626. Moreover, the optical modulator segments 610a and 610b and the heater sections 612a-612c are arranged in a similar manner in the semiconductor photonics device 616 as the optical modulator segments 210a and 210b and the heater sections 212a-212c in the semiconductor photonics device 216, except that the heater sections 612a-612c extend through the dielectric layer 620 in the z-direction. Moreover, the connecting heater section 612d is included in the dielectric layer 622 and extends over the optical modulator segments 610a and 610b and is connected with the heater sections 612a-612c. This results in the modulator heater structure 612 having an approximate trident shape in the cross-section view along the line C-C, in that the heater sections 612a-612c extend downward in the z-direction from connecting heater section 612d alongside the optical modulator segments 610a and 610b of the optical modulator structure 606. This enables the modulator heater structure 612 to radiate heat toward at least three sides of the optical modulator segments 610a and 610b, which may enable the heat generated by the modulator heater structure 612 to be more evenly distributed across the optical modulator structure 606. In particular, the heater sections 612a and 612c may respectively radiate heat toward the outer side and the inner side of the optical modulator segment 610a, and the connecting heater section 612d may radiate heat toward the top side of the optical modulator segment 610a. Similarly, the heater sections 612b and 612c may respectively radiate heat toward the outer side and the inner side of the optical modulator segment 610b, and the connecting heater section 612d may radiate heat toward the top side of the optical modulator segment 610b.

As indicated above, FIGS. 6A and 6B are provided as examples. Other examples may differ from what is described with regard to FIGS. 6A and 6B.

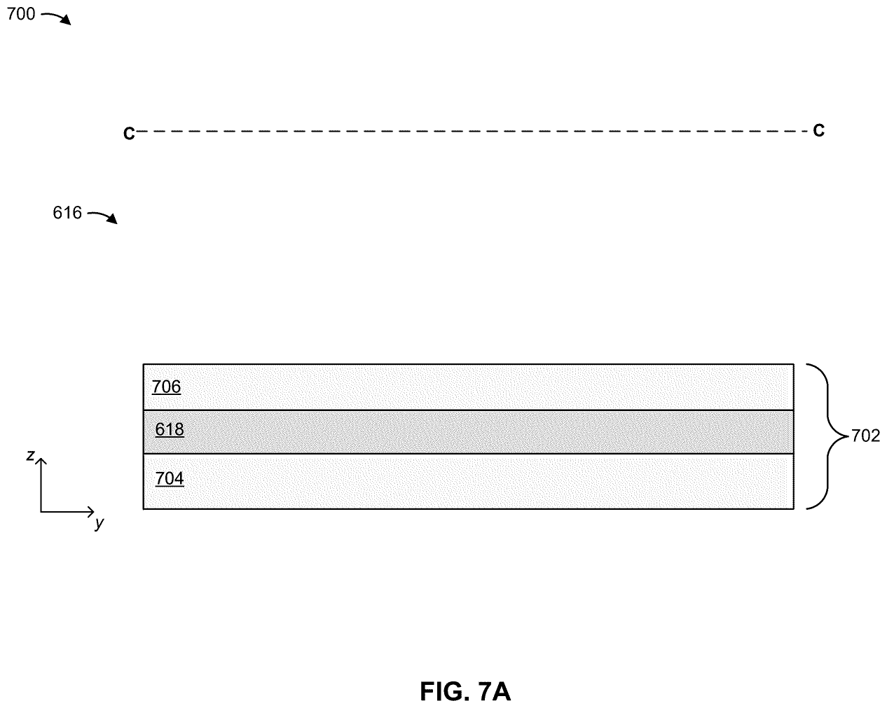

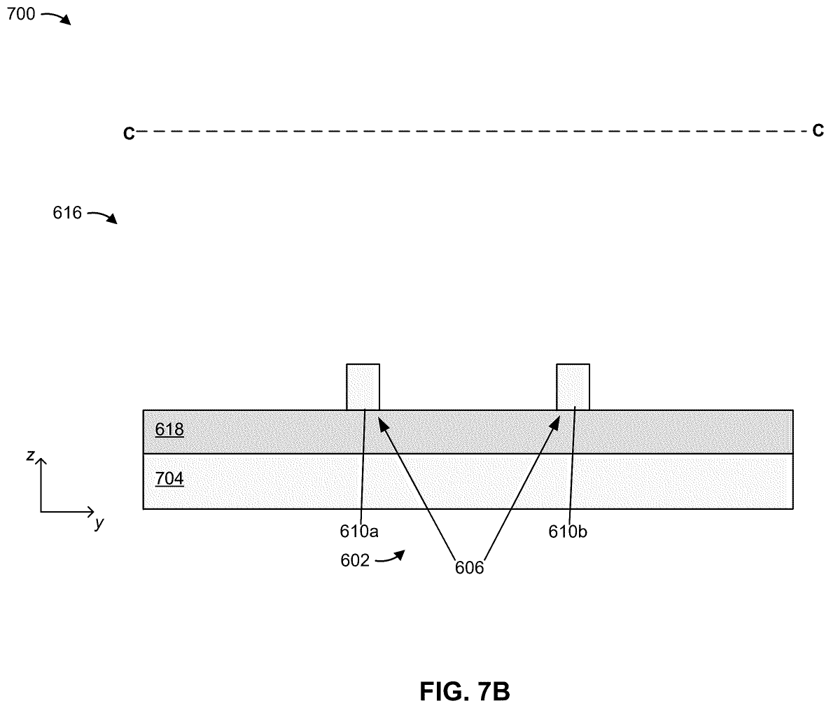

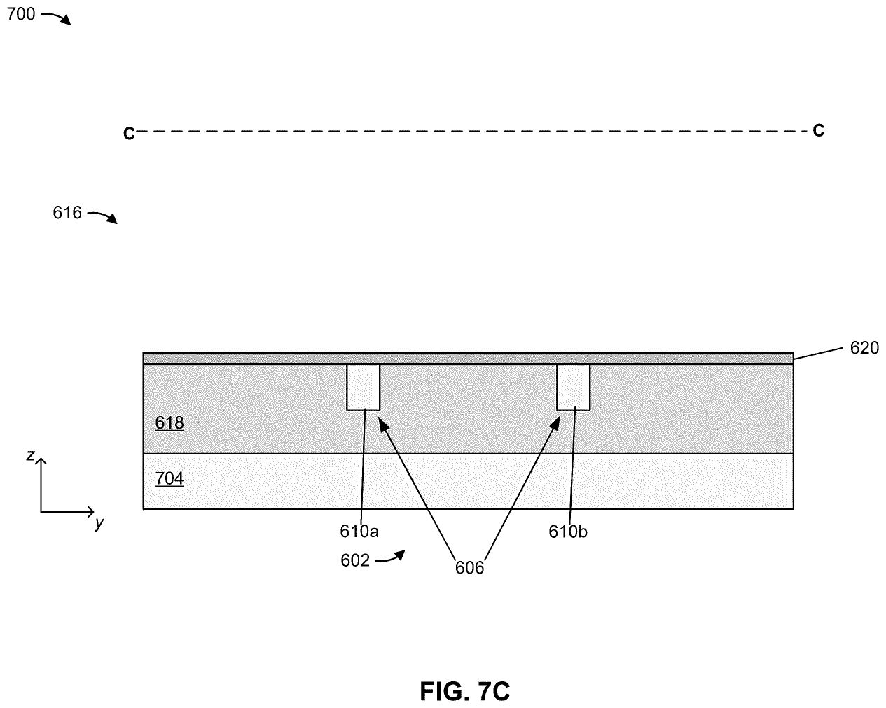

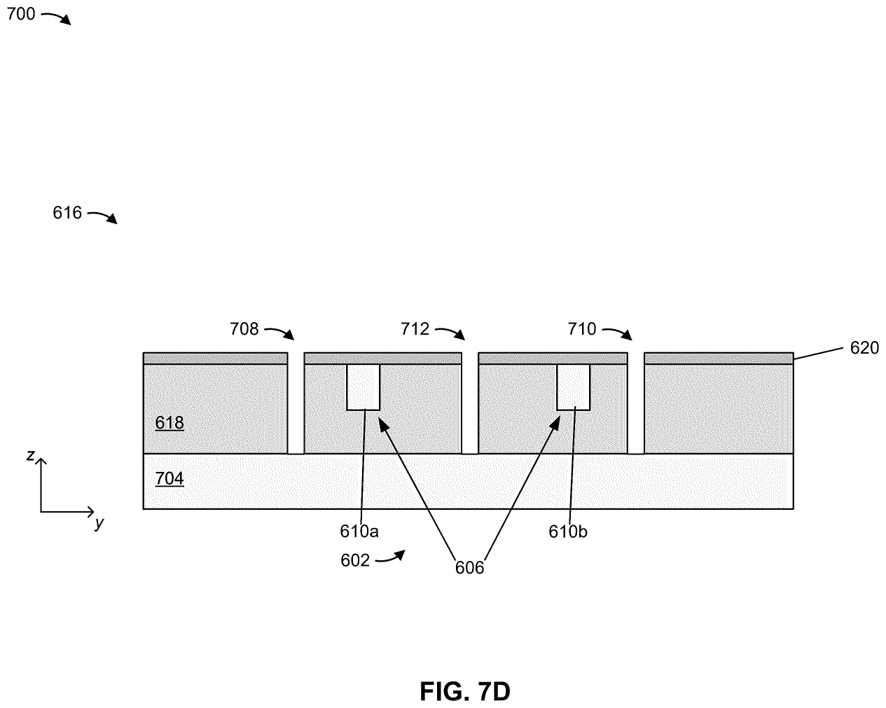

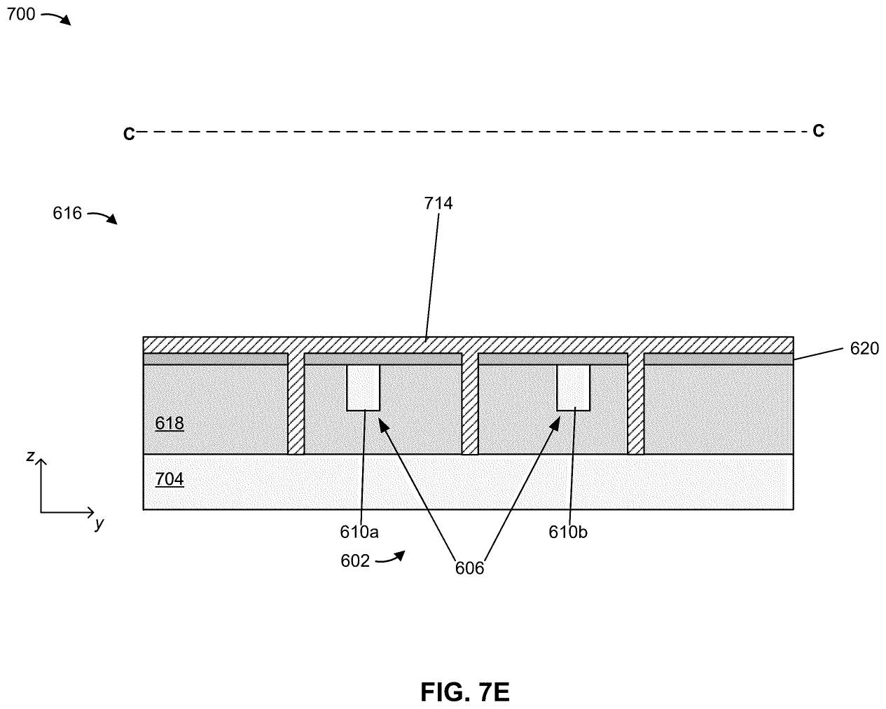

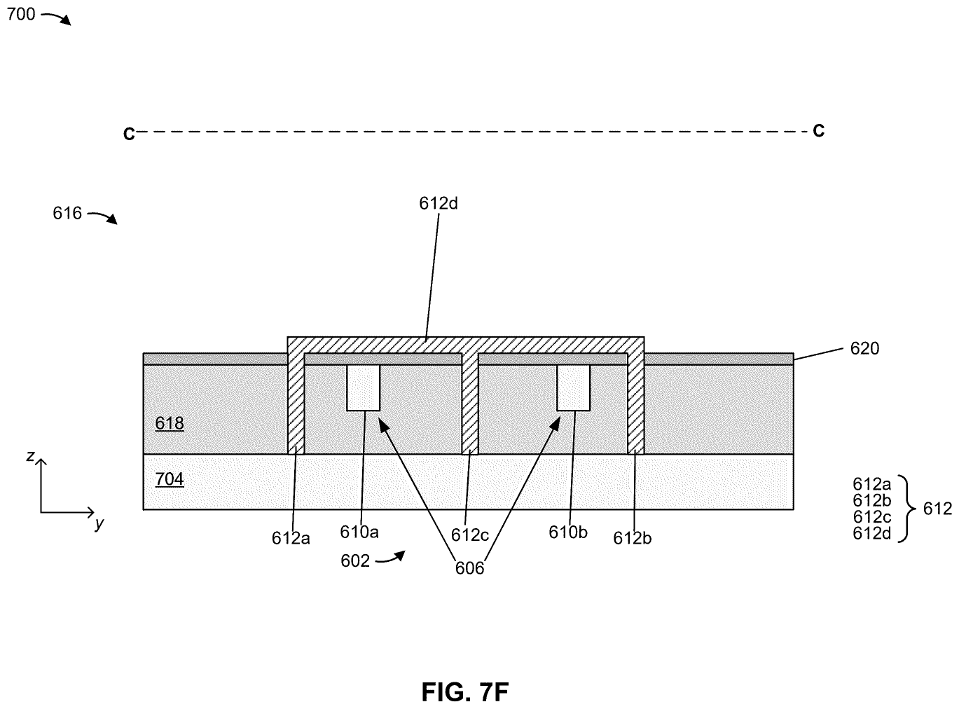

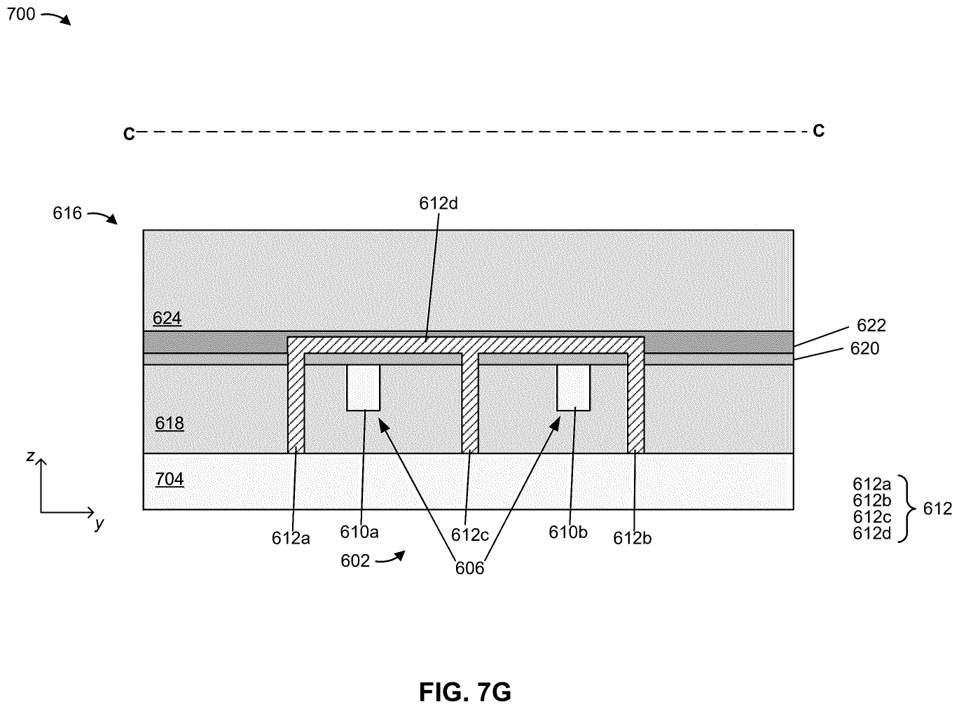

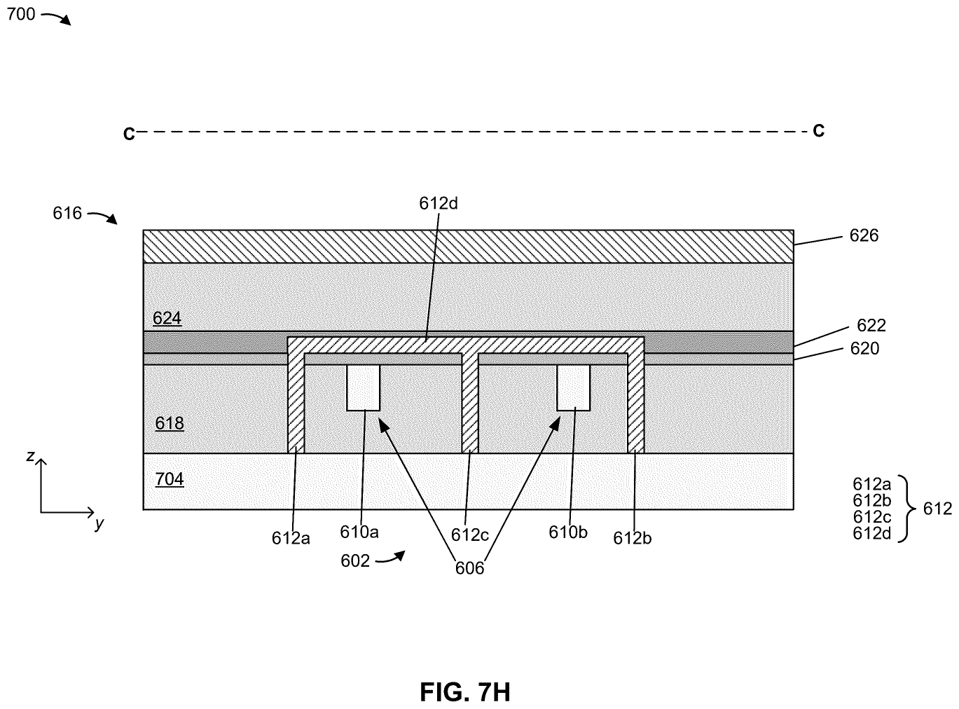

FIGS. 7A-7H are diagrams of an example 700 of forming the semiconductor photonics device 616 described herein. In particular, the example 700 includes an example of forming the photonic integrated circuit 602 and the associated modulator heater structure 612 in the semiconductor photonics device 616. In some implementations, one or more of the semiconductor processing operations described in connection with FIGS. 7A-7H are performed using one or more semiconductor processing tools, such as a deposition tool, an exposure tool, a developer tool, an etch tool, a plating tool, a planarization tool, an ion implantation tool, a wafer/die transport tool, and/or another type of semiconductor processing tool.

Turning to FIG. 7A, a substrate 702 may be provided. The substrate 702 may include an SOI substrate that includes a semiconductor substrate 704, a portion of the dielectric layer 618 over and/or on the semiconductor substrate 704, and a semiconductor layer 706 over and/or on the portion of the dielectric layer 618. Alternatively, the semiconductor substrate 704 may be provided as a semiconductor wafer, and a deposition tool may be used to form the portion of the dielectric layer 618 over and/or on the semiconductor substrate 704, and may form the semiconductor layer 706 over and/or on the portion of the dielectric layer 618.

As shown in FIGS. 7B and 7C, the optical modulator structure 606 (including the optical modulator segments 610a and 610b) may be formed in the semiconductor layer 706 such that the optical modulator structure 606 is located above the portion of the dielectric layer 618. The waveguide structures 604 and 608 (not shown in the cross-section view along the line C-C) may also be formed in the semiconductor layer 706 above the portion of the dielectric layer 618 along with the optical modulator structure 606. Additional material of the dielectric layer 618 may be deposited around the optical modulator structure 606 (and the waveguide structures 604 and 608). Similar process operations and/or techniques described in connection with FIGS. 3B and 3C may be used to form the optical modulator structure 606 and the additional material of the dielectric layer 618.

As further shown in FIG. 7C, the dielectric layer 620 may be formed over and/or on the dielectric layer 618 and over and/or on the optical modulator structure 606. The dielectric layer 620 may be formed in a similar manner as described in connection with FIG. 3F, except that the dielectric layer 620 may be formed over and/or on the optical modulator segments 610a and 610b of the optical modulator structure 606 prior to formation of the heater sections 612a-612c of the modulator heater structure 612.

As shown in FIG. 7D, recesses 708, 710, and 712 through the dielectric layer 620 and into a portion of in the dielectric layer 618. The recesses 708, 710, and 712 extend alongside the optical modulator segments 610a and 610b of the optical modulator structure 606. For example, the recess 708 may be formed adjacent to an outer side of the optical modulator segment 610a in the dielectric layer 618. As another example, the recess 710 may be formed adjacent to an outer side of the optical modulator segment 610b in the dielectric layer 618. As another example, the recess 712 may be formed adjacent to inner sides of the optical modulator segments 610a and 610b in the dielectric layer 618.

In some implementations, a pattern in a photoresist layer is used to etch the dielectric layers 618 and/or 620 to form the recesses 708, 710, and/or 712. In these implementations, a deposition tool may be used to form the photoresist layer on the dielectric layer 620. An exposure tool may be used to expose the photoresist layer to a radiation source to pattern the photoresist layer. A developer tool may be used to develop and remove portions of the photoresist layer to expose the pattern. An etch tool may be used to etch the dielectric layers 618 and/or 620 based on the pattern to form the recesses 708, 710, and 712. In some implementations, the etch operation includes a plasma etch operation, a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for forming the recesses 708, 710, and 712 based on a pattern.

In some implementations, the bottom surfaces of the recesses 708, 710, and 712 are approximately co-planar with the bottom surfaces of the optical modulator segments 610a and/or 610b. In some implementations, the bottom surfaces of the recesses 708, 710, and 712 are lower in the z-direction in the semiconductor photonics device 616 than the bottom surfaces of the optical modulator segments 610a and/or 610b. In some implementations, the bottom surfaces of the recesses 708, 710, and 712 are higher in the z-direction in the semiconductor photonics device 616 than the bottom surfaces of the optical modulator segments 610a and/or 610b.

As shown in FIG. 7E, the heater sections 612a-612c of the modulator heater structure 612 are respectively formed in the recesses 708, 710, and 712 such that the modulator heater structure 612 extends through the dielectric layer 620 and into the dielectric layer 618. The heater section 612a of the modulator heater structure 612 may be formed in the recess 708 such that the heater section 612a is located laterally adjacent to the outer side of the optical modulator segment 610a in the dielectric layer 618. The heater section 612b of the modulator heater structure 612 may be formed in the recess 710 such that the heater section 612b is located laterally adjacent to the outer side of the optical modulator segment 610b in the dielectric layer 618. The heater section 612c of the modulator heater structure 612 may be formed in the recess 712 such that the heater section 612c is located laterally adjacent to the inner sides of the optical modulator segments 610a and 610b in the dielectric layer 618. As further shown in FIG. 7E, a heater layer 714 may be formed over the dielectric layer 620 such that the heater layer 714 is coupled with the heater sections 612a-612c.

A deposition tool and/or a plating tool may be used to deposit the heater sections 612a-612c and the heater layer 714 using a CVD technique, a PVD technique, an ALD technique, an electroplating technique, and/or another suitable deposition technique. In some implementations, a planarization tool may be used to planarize the heater layer 714 after the heater layer 714 is deposited.

As shown in FIG. 7F, portions of the heater layer 714 may be removed to define the connecting heater section 612d of the modulator heater structure 612. In some implementations, a pattern in a hard mask layer is used to remove the portions of the heater layer 714 to define the connecting heater section 612d of the modulator heater structure 612. In some implementations, a pattern in a photoresist layer is used to remove the portions of the heater layer 714 to define the connecting heater section 612d of the modulator heater structure 612. Additionally and/or alternatively, the dielectric layer 622 may be formed on the dielectric layer 620, a recess may be formed in the dielectric layer 622, and the connecting heater section 612d may be formed in the recess such that the recess defines the connecting heater section 612d.

As shown in FIG. 7G, the dielectric layer 622 may be formed over and/or on the dielectric layer 620 and over and/or on the connecting heater section 612d of the modulator heater structure 612. The dielectric layer 624 may be formed over and/or on the dielectric layer 622. The dielectric layers 622 and 624 may be formed in a similar manner as described in connection with FIG. 3F.

As shown in FIG. 7H, a metallization layer 626 may be formed above the dielectric layer 624. Additionally and/or alternatively, the metallization layer 626 may be formed in a recess in the dielectric layer 624. The metallization layer 626 may be formed in a similar manner as the metallization layer 226 as described above in connection with FIG. 3G.

As indicated above, FIGS. 7A-7H are provided as an example. Other examples may differ from what is described with regard to FIGS. 7A-7H.

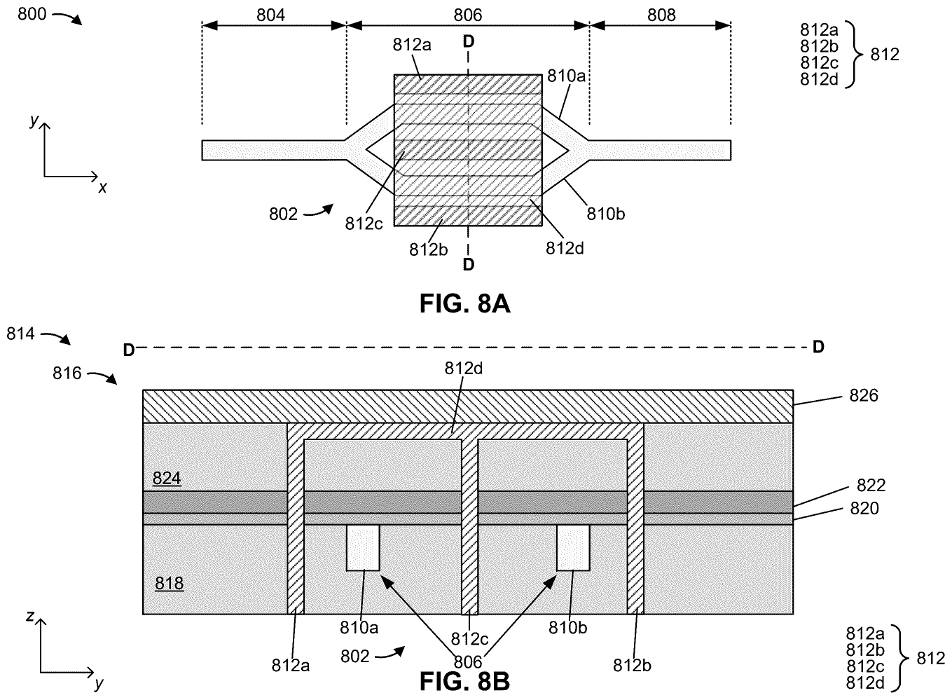

FIGS. 8A and 8B are diagrams of examples of a photonic integrated circuit and an associated semiconductor photonics device in which the photonic integrated circuit may be included. FIG. 8A illustrates a top view of an example 800 of a photonic integrated circuit 802. The photonic integrated circuit 802 is similar to the photonic integrated circuit 102 illustrated in FIG. 1, and includes a waveguide structure 804, an optical modulator structure 806, and a waveguide structure 808. The optical modulator structure 806 includes optical modulator segments 810a and 810b. As further shown in FIG. 8A, the example 800 further includes a modulator heater structure 812 proximate to the optical modulator structure 806. The modulator heater structure 812 is similar to the modulator heater structure 612 illustrated in FIGS. 6A and 6B, and includes a plurality of heater sections 812a-812c and a connecting heater section 812d.

FIG. 8B illustrates an example 814 of a semiconductor photonics device 816 in which the photonics integrated circuit 802 and associated modulator heater structure 812 may be included. FIG. 8B illustrates a cross-section view along the line D-D in FIG. 8A. In particular, the cross-section view is across the optical modulator segments 810a and 810b and across the heater sections 812a-812c in the y-direction. Thus, FIG. 8B illustrates the cross-section view in a y-z plane in the semiconductor photonics device 816.

As shown in FIG. 8B, the semiconductor photonics device 816 is similar to the semiconductor photonics device 616 and includes dielectric layers 818, 820, 822, and/or 824, and a metallization layer 826. Moreover, the optical modulator segments 810a and 810b, the heater sections 812a-812c, and the connecting heater section 812d are arranged in a similar manner in the semiconductor photonics device 816 as the optical modulator segments 610a and 610b, the heater sections 612a-612c, and the connecting heater section 612d, respectively, in the semiconductor photonics device 616. However, in the semiconductor photonics device 816, the heater sections 812a-812c extend through the dielectric layers 820, 822, and 824 in the z-direction. Moreover, the connecting heater section 812d is included in the dielectric layer 824 (e.g., as opposed to the dielectric layer 622 in which the connecting heater section 612d is included) and is electrically coupled and/or physically coupled with the metallization layer 826. This enables the formation of the heater sections 812a-812c and formation of the connecting heater section 812d to be combined with formation of electrical contacts (e.g., electrical contacts for the photonic integrated circuit 802) in the semiconductor photonics device 816, which reduces the manufacturing cost, time, and/or complexity for forming the semiconductor photonics device 816.

As indicated above, FIGS. 8A and 8B are provided as examples. Other examples may differ from what is described with regard to FIGS. 8A and 8B.

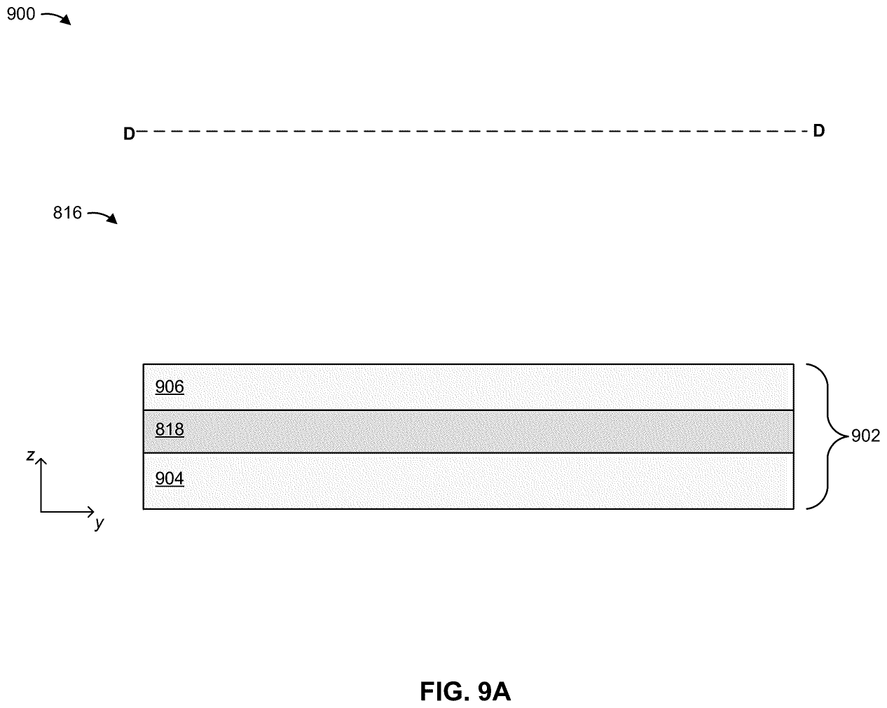

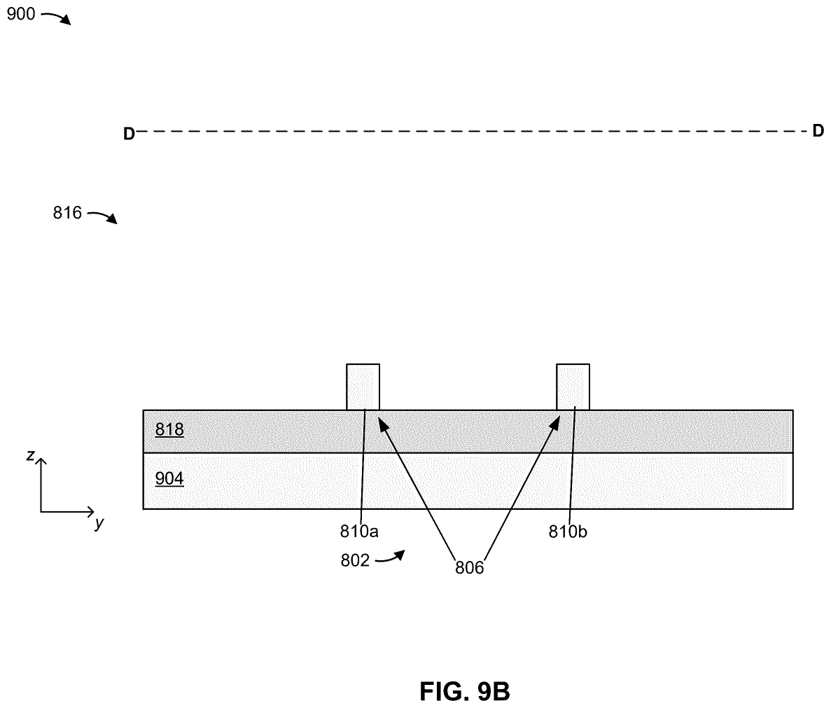

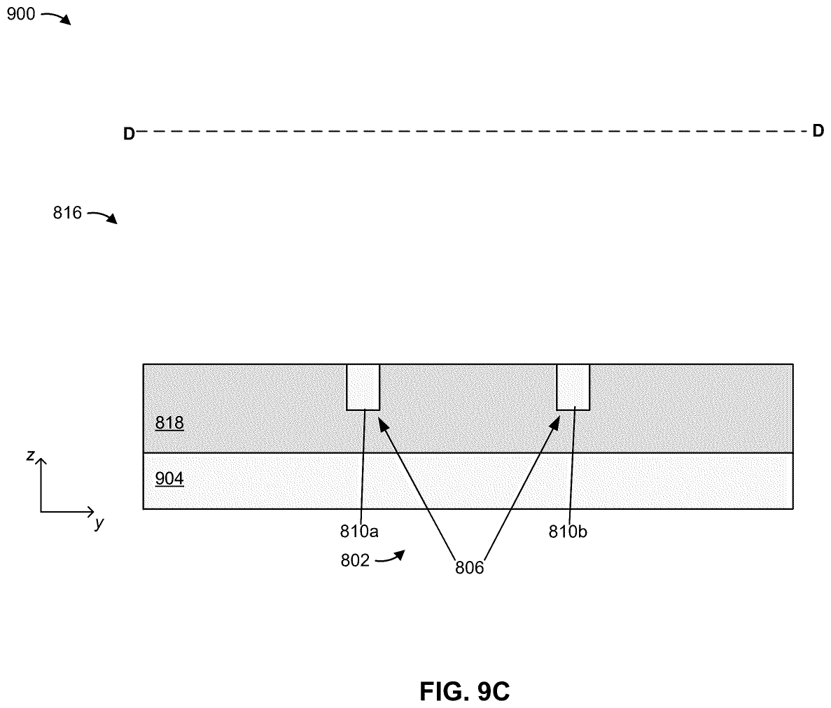

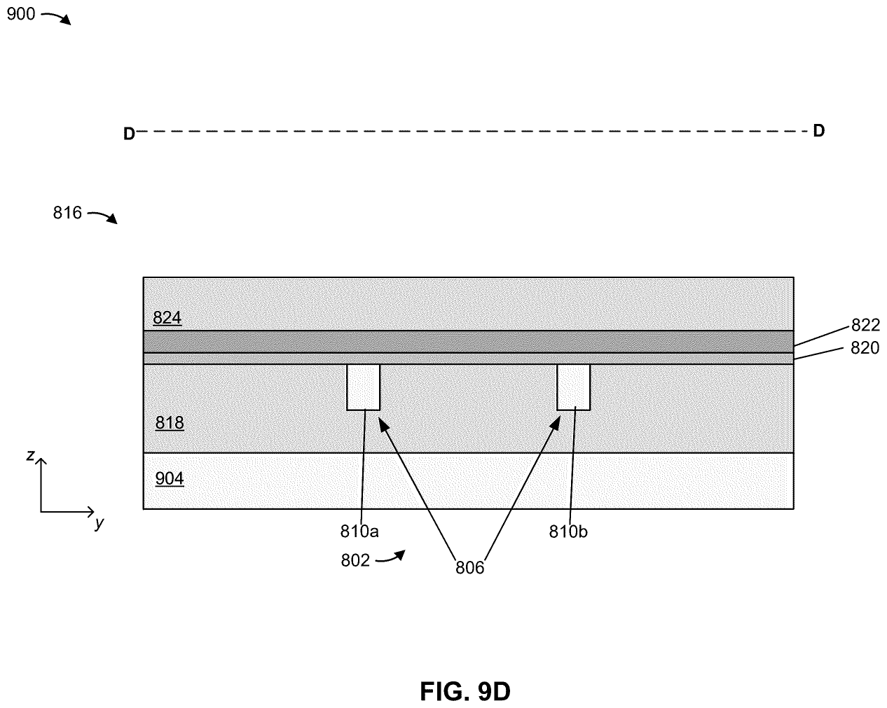

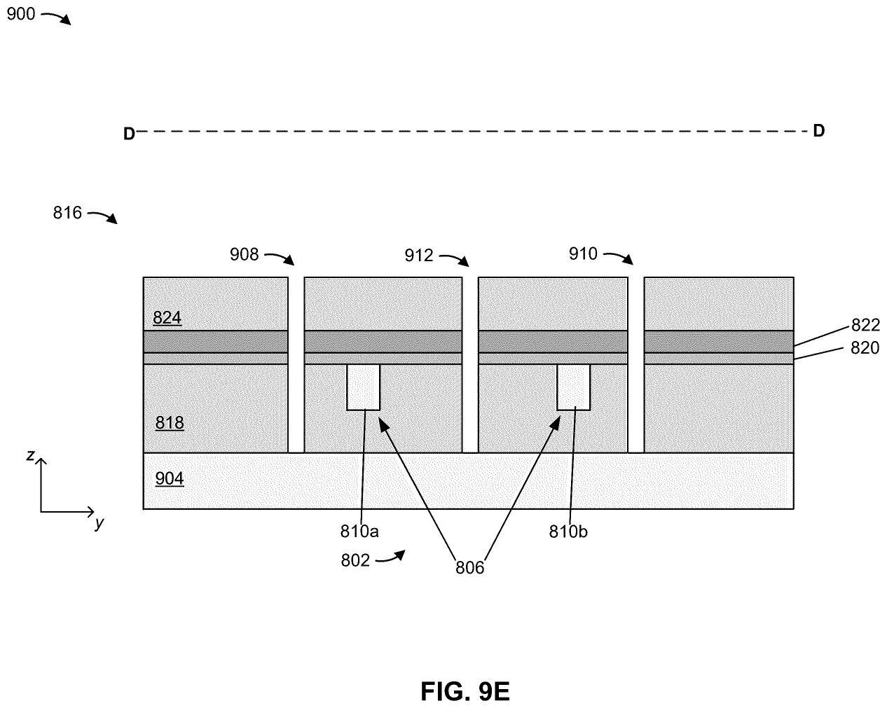

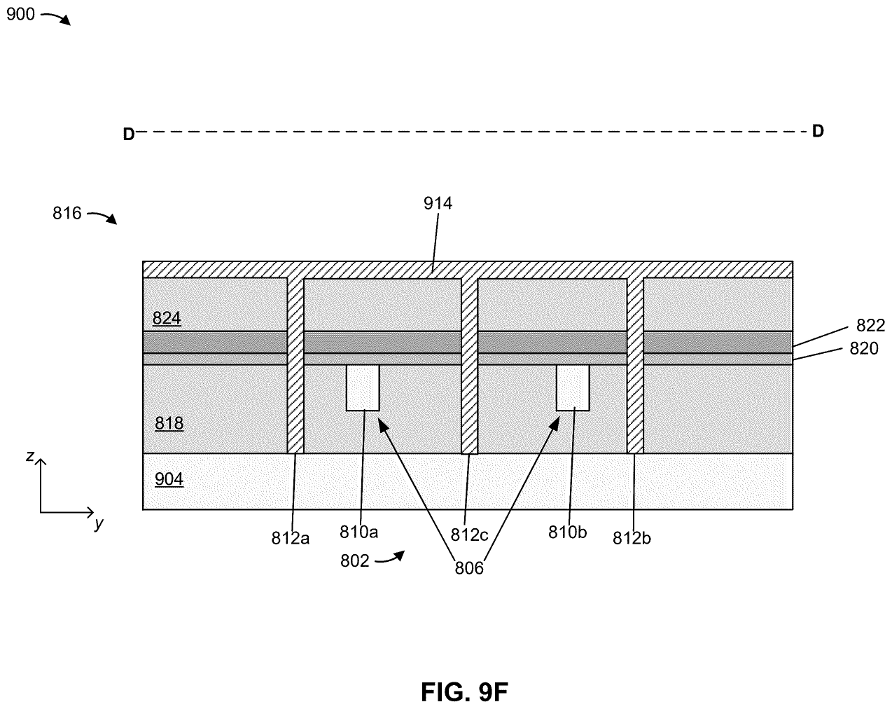

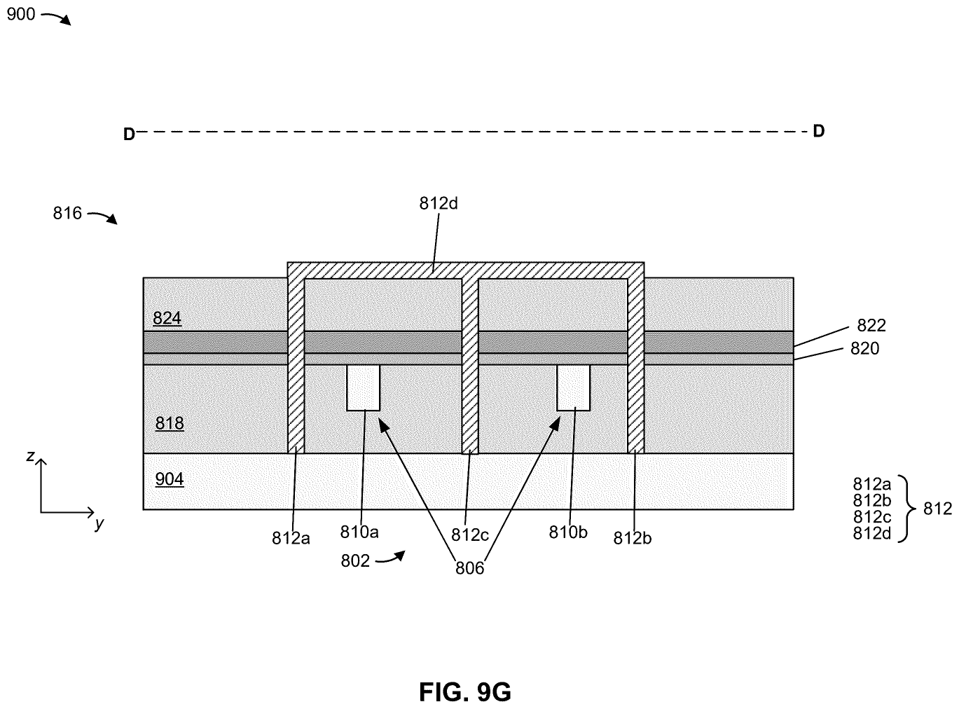

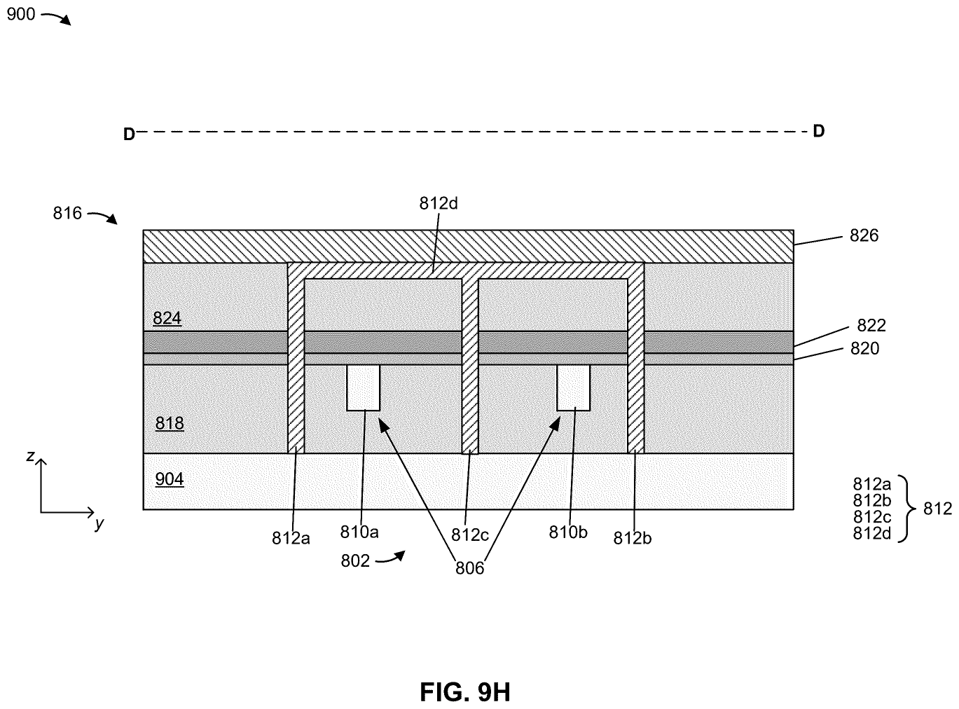

FIGS. 9A-9H are diagrams of an example 900 of forming the semiconductor photonics device 816 described herein. In particular, the example 900 includes an example of forming the photonic integrated circuit 802 and the associated modulator heater structure 812 in the semiconductor photonics device 816. In some implementations, one or more of the semiconductor processing operations described in connection with FIGS. 9A-9H are performed using one or more semiconductor processing tools, such as a deposition tool, an exposure tool, a developer tool, an etch tool, a plating tool, a planarization tool, an ion implantation tool, a wafer/die transport tool, and/or another type of semiconductor processing tool.

Turning to FIG. 9A, a substrate 902 may be provided. The substrate 902 may include an SOI substrate that includes a semiconductor substrate 904, a portion of the dielectric layer 818 over and/or on the semiconductor substrate 904, and a semiconductor layer 906 over and/or on the portion of the dielectric layer 818. Alternatively, the semiconductor substrate 904 may be provided as a semiconductor wafer, and a deposition tool may be used to form the portion of the dielectric layer 818 over and/or on the semiconductor substrate 904, and may form the semiconductor layer 906 over and/or on the portion of the dielectric layer 818.

As shown in FIGS. 9B and 9C, the optical modulator structure 806 (including the optical modulator segments 810a and 810b) may be formed in the semiconductor layer 906 such that the optical modulator structure 806 is located above the portion of the dielectric layer 818. The waveguide structures 804 and 808 (not shown in the cross-section view along the line D-D) may also be formed in the semiconductor layer 906 above the portion of the dielectric layer 818 along with the optical modulator structure 806. Additional material of the dielectric layer 818 may be deposited around the optical modulator structure 806 (and the waveguide structures 804 and 808). Similar process operations and/or techniques described in connection with FIGS. 3B and 3C may be used to form the optical modulator structure 806 and the additional material of the dielectric layer 818.

As shown in FIG. 9D, the dielectric layer 820 may be formed over and/or on the dielectric layer 818, the dielectric layer 822 may be formed over and/or on the dielectric layer 820, and the dielectric layer 824 may be formed over and/or on the dielectric layer 822 in a similar manner as described in connection with FIG. 3F. However, the dielectric layer 820 is formed over and/or on the optical modulator segments 810a and 810b of the optical modulator structure 806 prior to formation of the heater sections 812a-812c of the modulator heater structure 812. This is because the heater sections 812a-812c of the modulator heater structure 812 are formed as part of the contact formation process for the semiconductor photonics device 816.

As shown in FIGS. 9E-9G, the contact formation process may be performed to form the heater sections 812a-812c and the connecting heater section 812d of the modulator heater structure 812 along with contacts (not shown in the cross-section view along the line D-D) for the photonic integrated circuit 802 and/or for other devices in the semiconductor photonics device 816. The heater sections 812a-812c and the connecting heater section 812d may also function as the contacts for the modulator heater structure 812.

As shown in FIG. 9E, the contact formation process may include forming recesses 908, 910, and 912 through the dielectric layer 824, through the dielectric layer 822, through the dielectric layer 820, and into a portion of in the dielectric layer 818 next to the optical modulator segments 810a and 810b of the optical modulator structure 806. For example, the recess 908 may be formed adjacent to an outer side of the optical modulator segment 810a in the dielectric layer 818. As another example, the recess 910 may be formed adjacent to an outer side of the optical modulator segment 810b in the dielectric layer 818. As another example, the recess 912 may be formed adjacent to inner sides of the optical modulator segments 810a and 810b in the dielectric layer 818.

In some implementations, a pattern in a photoresist layer is used to etch the dielectric layers 818, 820, 822, and/or 824 to form the recesses 908, 910, and/or 912. In these implementations, a deposition tool may be used to form the photoresist layer on the dielectric layer 824. An exposure tool may be used to expose the photoresist layer to a radiation source to pattern the photoresist layer. A developer tool may be used to develop and remove portions of the photoresist layer to expose the pattern. An etch tool may be used to etch the dielectric layers 818, 820, 822, and/or 824 based on the pattern to form the recesses 908, 910, and/or 912. In some implementations, the etch operation includes a plasma etch operation, a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for forming the recesses 908, 910, and/or 912 based on a pattern.

In some implementations, the bottom surfaces of the recesses 908, 910, and/or 912 are approximately co-planar with the bottom surfaces of the optical modulator segments 810a and/or 810b. In some implementations, the bottom surfaces of the recesses 908, 910, and/or 912 are lower in the z-direction in the semiconductor photonics device 816 than the bottom surfaces of the optical modulator segments 810a and/or 810b. In some implementations, the bottom surfaces of the recesses 908, 910, and/or 912 are higher in the z-direction in the semiconductor photonics device 816 than the bottom surfaces of the optical modulator segments 810a and/or 810b.

As shown in FIG. 9F, the heater sections 812a-812c of the modulator heater structure 812 are respectively formed in the recesses 908, 910, and 912 such that the heater sections 812a-812c of the modulator heater structure 812 extend through the dielectric layers 820, 822, and 824, and into the dielectric layer 818. The heater section 812a of the modulator heater structure 812 may be formed in the recess 908 such that the heater section 812a is located laterally adjacent to the outer side of the optical modulator segment 810a in the dielectric layer 818. The heater section 812b of the modulator heater structure 812 may be formed in the recess 910 such that the heater section 812b is located laterally adjacent to the outer side of the optical modulator segment 810b in the dielectric layer 818. The heater section 812c of the modulator heater structure 812 may be formed in the recess 912 such that the heater section 812c is located laterally adjacent to the inner sides of the optical modulator segments 810a and 810b in the dielectric layer 818.

As further shown in FIG. 9F, a heater layer 914 may be formed over the dielectric layer 824 such that the heater layer 914 is coupled with the heater sections 812a-812c. A deposition tool and/or a plating tool may be used to deposit the heater sections 812a-812c and the heater layer 914 using a CVD technique, a PVD technique, an ALD technique, an electroplating technique, and/or another suitable deposition technique. In some implementations, a planarization tool may be used to planarize the heater layer 914 after the heater layer 914 is deposited.

As shown in FIG. 9G, portions of the heater layer 914 may be removed to define the connecting heater section 812d of the modulator heater structure 812. In some implementations, a pattern in a hard mask layer is used to remove the portions of the heater layer 914 to define the connecting heater section 812d of the modulator heater structure 812. In some implementations, a pattern in a photoresist layer is used to remove the portions of the heater layer 914 to define the connecting heater section 812d of the modulator heater structure 812. Additionally and/or alternatively, a recess may be formed in the dielectric layer 824, and the connecting heater section 812d may be formed in the recess such that the recess defines the connecting heater section 812d.

As shown in FIG. 9H, a metallization layer 826 may be formed above the dielectric layer 824. Additionally and/or alternatively, the metallization layer 826 may be formed in a recess in the dielectric layer 824. A portion of the metallization layer 826 may be formed on the connecting heater section 812d of the modulator heater structure 812 such that the connecting heater section 812d of the modulator heater structure 812 is electrically coupled and/or physically coupled with the metallization layer 826. The metallization layer 826 may be formed in a similar manner as the metallization layer 226 as described above in connection with FIG. 3G.

As indicated above, FIGS. 9A-9H are provided as an example. Other examples may differ from what is described with regard to FIGS. 9A-9H.

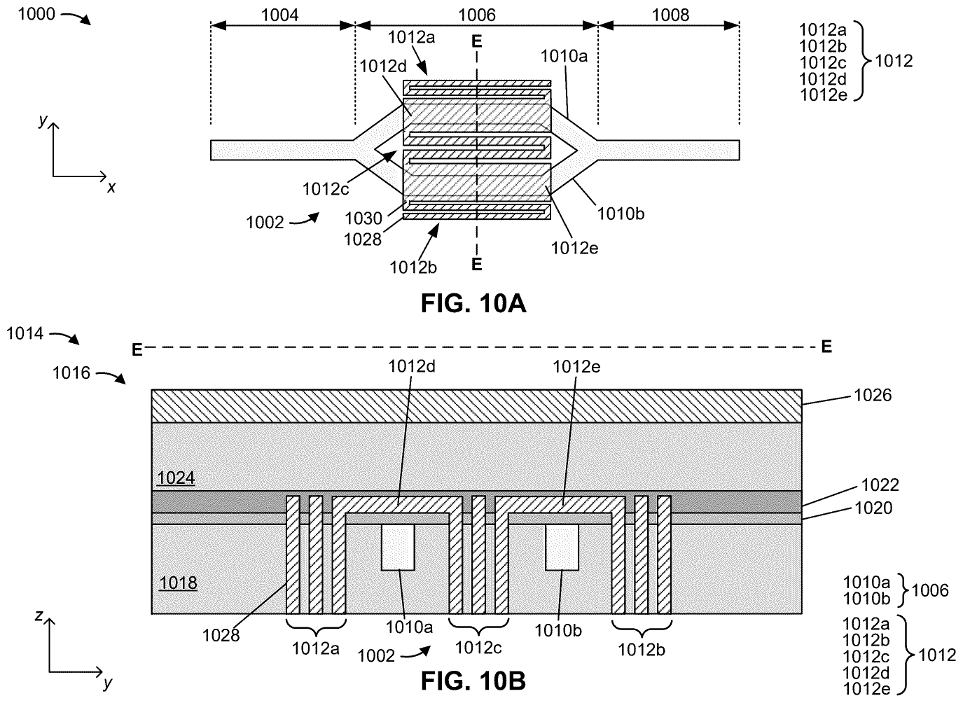

FIGS. 10A and 10B are diagrams of examples of a photonic integrated circuit and an associated semiconductor photonics device in which the photonic integrated circuit may be included. FIG. 10A illustrates a top view of an example 1000 of a photonic integrated circuit 1002. The photonic integrated circuit 1002 is similar to the photonic integrated circuit 102 illustrated in FIG. 1, and includes a waveguide structure 1004, an optical modulator structure 1006, and a waveguide structure 1008. The optical modulator structure 1006 includes optical modulator segments 1010a and 1010b.

As further shown in FIG. 10A, the example 1000 further includes a modulator heater structure 1012 proximate to the optical modulator structure 1006. The modulator heater structure 1012 is similar to the modulator heater structure 612 illustrated in FIGS. 6A and 6B, and includes a plurality of heater sections 1012a-1012c. However, each of the heater sections 1012a-1012c includes a plurality of segments 1028 that are interconnect by one or more connecting segments 1030. Some of the segments 1028 and connecting segments 1030 result in one or more of the heater sections 1012a-1012c having an approximate S-shape top view profile. In some implementations, one or more of the heater sections 1012a-1012c have an approximate U-shape top view profile. Additionally, the modulator heater structure 1012 includes a plurality of connecting heater sections, including a connecting heater section 1012d that connects the heater section 1012a and 1012c, and a connecting heater section 1012e that connects the heater section 1012b and 1012c. The segments 1028 may function as heater fins that radiate heat toward the optical modulator structure 1006. In particular, the segments 1028 and the associated connecting segments 1030 may provide increased surface area through which the heater sections 1012a-1012c may radiate heat toward the optical modulator segments 1010a and/or 1010b of the optical modulator structure 1006.

FIG. 10B illustrates an example 1014 of a semiconductor photonics device 1016 in which the photonics integrated circuit 1002 and associated modulator heater structure 1012 may be included. FIG. 10B illustrates a cross-section view along the line E-E in FIG. 10A. In particular, the cross-section view is across the optical modulator segments 1010a and 1010b and across the heater sections 1012a-1012c in the y-direction. Thus, FIG. 10B illustrates the cross-section view in a y-z plane in the semiconductor photonics device 1016.

As shown in FIG. 10B, the semiconductor photonics device 1016 is similar to the semiconductor photonics device 616 and includes dielectric layers 1018, 1020, 1022, and/or 1024, and a metallization layer 1026. Moreover, the heater sections 1012a-1012c, similar to the heater sections 612a-612c, extend alongside the optical modulator segments 1010a and 1010b in the dielectric layer 1018 and through the dielectric layer 1020. However, the heater sections 1012a-1012c include the segments 1028 that are arranged in the y-direction, as shown in FIG. 10B. In addition, the connecting heater sections 1012d and 1012e are included in the dielectric layer 1022.

The segments 1028 of the heater sections 1012a-1012c may at least partially extend into the dielectric layer 1022 such that the tops of the segments 1028 are approximately co-planar with the top surfaces of the connecting heater sections 1012d and 1012e. The connecting heater section 1012d is coupled with a segment 1028 of the heater section 1012a (e.g., either directly or through a connecting segment 1030) and is coupled with a segment 1028 of the heater section 1012c (e.g., either directly or through a connecting segment 1030). Similarly, the connecting heater section 1012e is coupled with a segment 1028 of the heater section 1012b (e.g., either directly or through a connecting segment 1030) and is coupled with a segment 1028 of the heater section 1012c (e.g., either directly or through a connecting segment 1030).

The semiconductor photonics device 1016 (including the photonic integrated circuit and the modulator heater structure 1012) may be formed by a similar set of processing operations for the semiconductor photonics device 616, as described above in connection with FIGS. 7A-7H. However, the recesses 708, 710, and 712 may be patterned to provide for formation of the segments 1028 and connecting segments 1030 of the heater sections 1012a-1012c in the dielectric layers 1018 and 1022. Moreover, the heater layer 714 may be patterned to provide for formation of the connecting heater sections 1012d and 1012e.

As indicated above, FIGS. 10A and 10B are provided as examples. Other examples may differ from what is described with regard to FIGS. 10A and 10B.

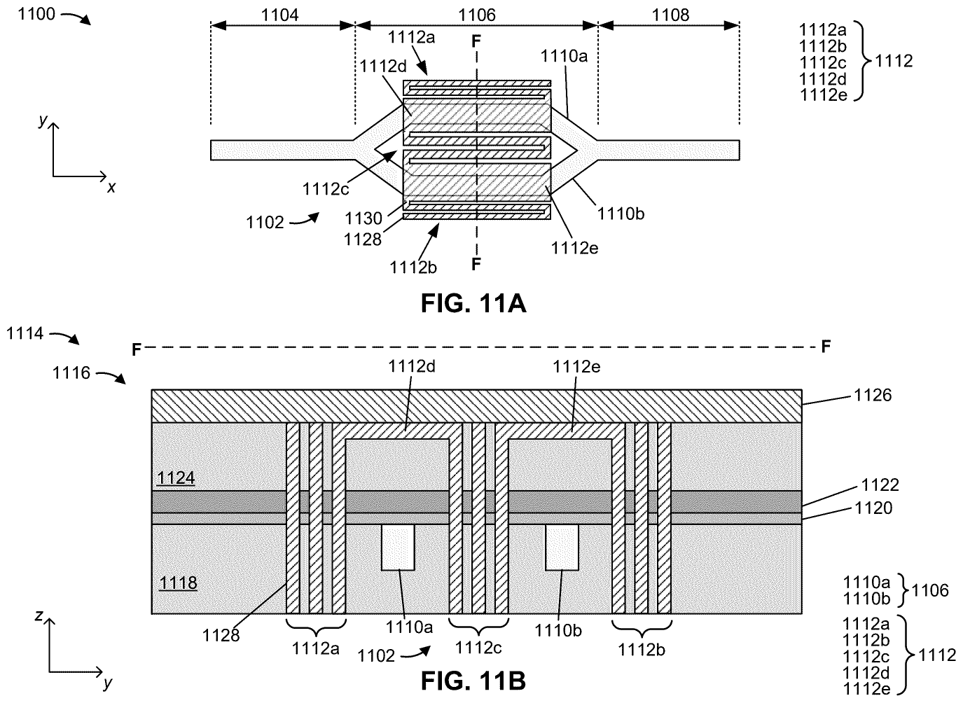

FIGS. 11A and 11B are diagrams of examples of a photonic integrated circuit and an associated semiconductor photonics device in which the photonic integrated circuit may be included. FIG. 11A illustrates a top view of an example 1100 of a photonic integrated circuit 1102. The photonic integrated circuit 1102 is similar to the photonic integrated circuit 102 illustrated in FIG. 1, and includes a waveguide structure 1104, an optical modulator structure 1106, and a waveguide structure 1108. The optical modulator structure 1106 includes optical modulator segments 1110a and 1110b.

As further shown in FIG. 11A, the example 1100 further includes a modulator heater structure 1112 proximate to the optical modulator structure 1106. The modulator heater structure 1112 is similar to the modulator heater structure 812 illustrated in FIGS. 8A and 8B, and includes a plurality of heater sections 1112a-1112c. However, each of the heater sections 1112a-1112c includes a plurality of segments 1128 that are interconnected by one or more connecting segments 1130. Some of the segments 1128 and connecting segments 1130 result in one or more of the heater sections 1112a-1112c having an approximate S-shape top view profile. In some implementations, one or more of the heater sections 1112a-1112c have an approximate U-shape top view profile. Additionally, the modulator heater structure 1112 includes a plurality of connecting heater sections, including a connecting heater section 1112d that connects the heater section 1112a and 1112c, and a connecting heater section 1112e that connects the heater section 1112b and 1112c. The segments 1128 may function as heater fins that radiate heat toward the optical modulator structure 1106. In particular, the segments 1128 and the associated connecting segments 1130 may provide increased surface area through which the heater sections 1112a-1112c may radiate heat toward the optical modulator segments 1110a and/or 1110b of the optical modulator structure 1106.

FIG. 11B illustrates an example 1114 of a semiconductor photonics device 1116 in which the photonics integrated circuit 1102 and associated modulator heater structure 1112 may be included. FIG. 11B illustrates a cross-section view along the line F-F in FIG. 11A. In particular, the cross-section view is across the optical modulator segments 1110a and 1110b and across the heater sections 1112a-1112c in the y-direction. Thus, FIG. 11B illustrates the cross-section view in a y-z plane in the semiconductor photonics device 1116.

As shown in FIG. 11B, the semiconductor photonics device 1116 is similar to the semiconductor photonics device 816 and includes dielectric layers 1118, 1120, 1122, and/or 1124, and a metallization layer 1126. Moreover, the heater sections 1112a-1112c, similar to the heater sections 812a-812c, extend alongside the optical modulator segments 1110a and 1110b in the dielectric layer 1118 and through the dielectric layers 1120, 1122, and 1124 to the metallization layer 1126. However, the heater sections 1112a-1112c include the segments 1128 that are arranged in the y-direction, as shown in FIG. 11B.

The segments 1128 of the heater sections 1112a-1112c may extend through the dielectric layer 1124 such that the tops of the segments 1128 are coupled with the metallization layer 1126 and are approximately co-planar with the top surfaces of the connecting heater sections 1112d and 1112e. The connecting heater sections 1112d and 1112e are included in the dielectric layer 1124 and coupled with the metallization layer 1126. The connecting heater section 1112d is coupled with a segment 1128 of the heater section 1112a (e.g., either directly or through a connecting segment 1130) and is coupled with a segment 1128 of the heater section 1112c (e.g., either directly or through a connecting segment 1130). Similarly, the connecting heater section 1112e is coupled with a segment 1128 of the heater section 1112b (e.g., either directly or through a connecting segment 1130) and is coupled with a segment 1128 of the heater section 1112c (e.g., either directly or through a connecting segment 1130).

The semiconductor photonics device 1116 (including the photonic integrated circuit and the modulator heater structure 1112) may be formed by a similar set of processing operations for the semiconductor photonics device 816, as described above in connection with FIGS. 9A-9H. However, the recesses 908, 910, and 912 may be patterned to provide for formation of the segments 1128 and connecting segments 1130 of the heater sections 1112a-1112c in the dielectric layers 1118 and 1122. Moreover, the heater layer 914 may be patterned to provide for formation of the connecting heater sections 1112d and 1112e.

As indicated above, FIGS. 11A and 11B are provided as examples. Other examples may differ from what is described with regard to FIGS. 11A and 11B.

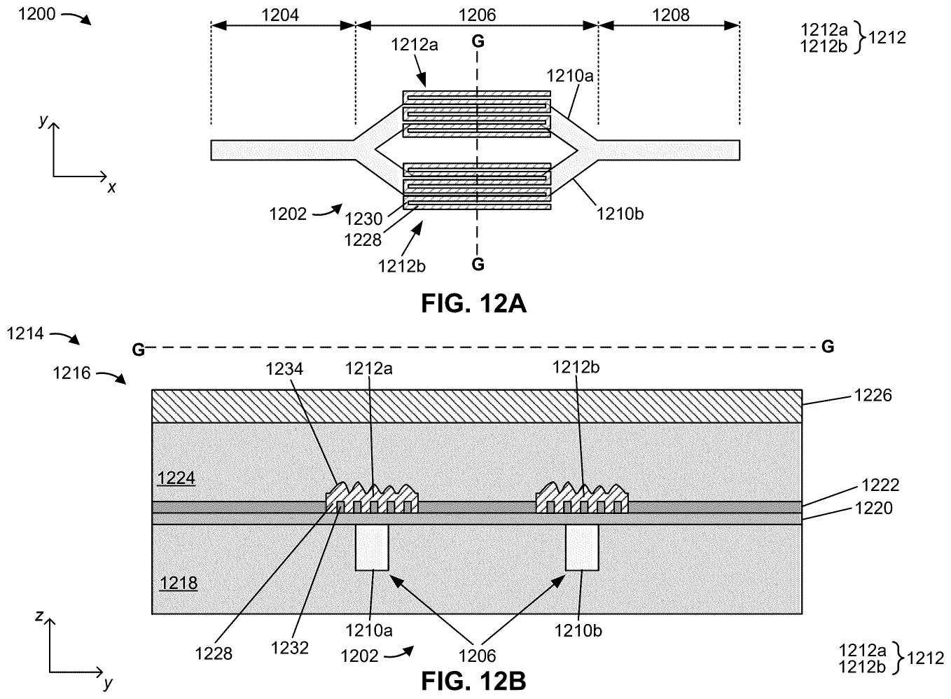

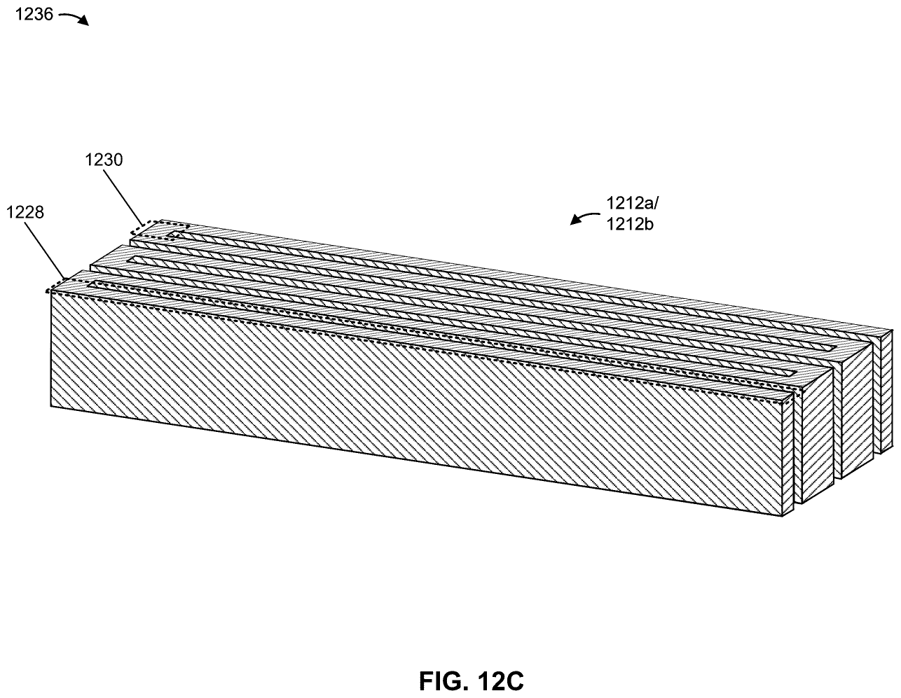

FIGS. 12A-12C are diagrams of examples of a photonic integrated circuit and an associated semiconductor photonics device in which the photonic integrated circuit may be included. FIG. 12A illustrates a top view of an example 1200 of a photonic integrated circuit 1202. The photonic integrated circuit 1202 is similar to the photonic integrated circuit 102 illustrated in FIG. 1, and includes a waveguide structure 1204, an optical modulator structure 1206, and a waveguide structure 1208. The optical modulator structure 1206 includes optical modulator segments 1210a and 1210b.

As further shown in FIG. 12A, the example 1200 further includes a modulator heater structure 1212 proximate to the optical modulator structure 1206 similar to the example 200 of the modulator heater structure 212. However, the modulator heater structure 1212 differs from the modulator heater structure 212 in that the heater sections 1212a and 1212b of the modulator heater structure 1212 are located above the optical modulator segments 1210a and 1210b, as opposed to being located laterally adjacent to the optical modulator segments 1210a and 1210b. For example, the heater section 1212a may be located above the optical modulator segment 1210a, and the heater section 1212b may be located above the optical modulator segment 1210b.

As further shown in FIG. 12A, the heater sections 1212a and 1212b may each include a plurality of segments 1228 and one or more connecting segments 1230 that couple the segments 1228 together. The connecting segments 1230 of the heater section 1212a may be located at opposing ends of alternating segments 1228 such that the segments 1228 and the connecting segments 1230 form a repeating pattern in the top view of the modulator heater structure 1212, where the repeating pattern approximately corresponds to a rectangular wave shape. In the example 1200, the segments 1228 are arranged in a direction (e.g., the y-direction) that is approximately perpendicular to the optical modulator segments 1210a and 1210b, and extend in a direction (e.g., the x-direction) that is approximately parallel to the optical modulator segments 1210a and 1210b. The heater section 1212b may have a similar arrangement of segments 1228 and connecting segments 1230.

The segments 1228 may function as heater fins that radiate heat toward the optical modulator structure 1206. In particular, the segments 1228 and the associated connecting segments 1230 may provide increased surface area (e.g., relative to solid rectangular heater sections) through which the heater sections 1212a and 1212b may radiate heat toward the optical modulator segments 1210a and/or 1210b of the optical modulator structure 1206.

FIG. 12B illustrates an example 1214 of a semiconductor photonics device 1216 in which the photonics integrated circuit 1202 and associated modulator heater structure 1212 may be included. FIG. 12B illustrates a cross-section view along the line G-G in FIG. 12A. In particular, the cross-section view is across the optical modulator segments 1210a and 1210b and across the heater sections 1212a and 1212b in the y-direction. Thus, FIG. 12B illustrates the cross-section view in a y-z plane in the semiconductor photonics device 1216.

As shown in FIG. 12B, the semiconductor photonics device 1216 is similar to the semiconductor photonics device 216 and includes dielectric layers 1218, 1220, 1222, and/or 1224, and a metallization layer 1226. Moreover, the optical modulator segments 1210a and 1210b are arranged in a similar manner in the semiconductor photonics device 1216 as the optical modulator segments 210a and 210b in the semiconductor photonics device 216. The heater sections 1212a and 1212b differ from the heater sections 212a-212c of the semiconductor photonics device 216 in that the heater sections 1212a and 1212b are located above the optical modulator segments 1210a and 1210b and are included in the dielectric layer 1222.

As further shown in in FIG. 12B, the segments 1228 of the heater section 1212a (and the segments 1228 of the heater section 1212b) are defined by dielectric spacers 1232 that are formed from the dielectric layer 1222. Moreover, the heater section 1212a and the heater section 1212b each have a wavy top (or non-flat) surface 1234 (e.g., the top surface 1234 has a wavy cross-sectional profile) that results from the omission of a planarization operation for the heater section 1212a and the heater section 1212b.

FIG. 12C illustrates an example 1236 of a heater section 1212a or 1212b. As shown in FIG. 12C, the segments 1228 of the heater section 1212a (or of the heater section 1212b) may include elongated structures that extend approximately parallel to each other. The connecting segments 1230 of the heater section 1212a (or of the heater section 1212b) may connect ends of adjacent segments 1228 together, and may be arranged in an alternating manner. For example, a first connecting segment 1230 may connect first ends of a first segment 1228 and an adjacent second segment 1228, a second connecting segment 1230 may connect second ends (opposing the first ends) of the second segment 1228 and an adjacent third segment 1228, a third connecting segment 1230 may connect first ends (opposing the second ends) of the third segment 1228 and an adjacent fourth segment 1228, and so on.

As indicated above, FIGS. 12A-12C are provided as examples. Other examples may differ from what is described with regard to FIGS. 12A-12C.

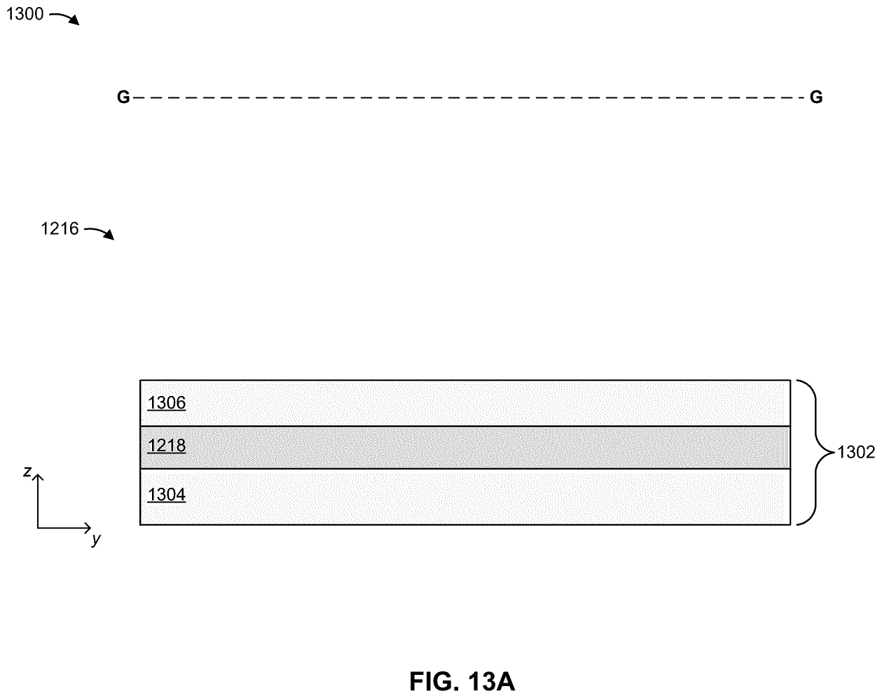

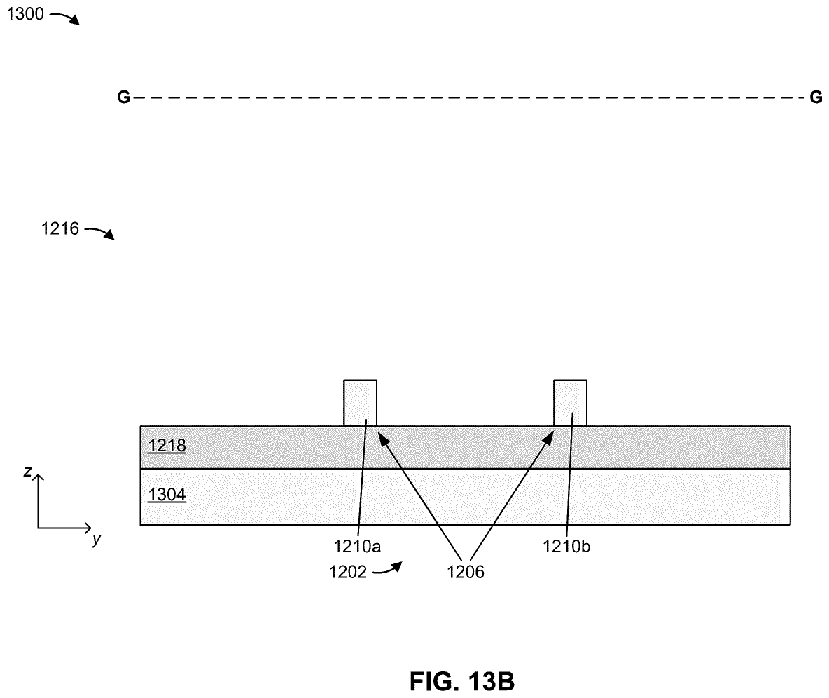

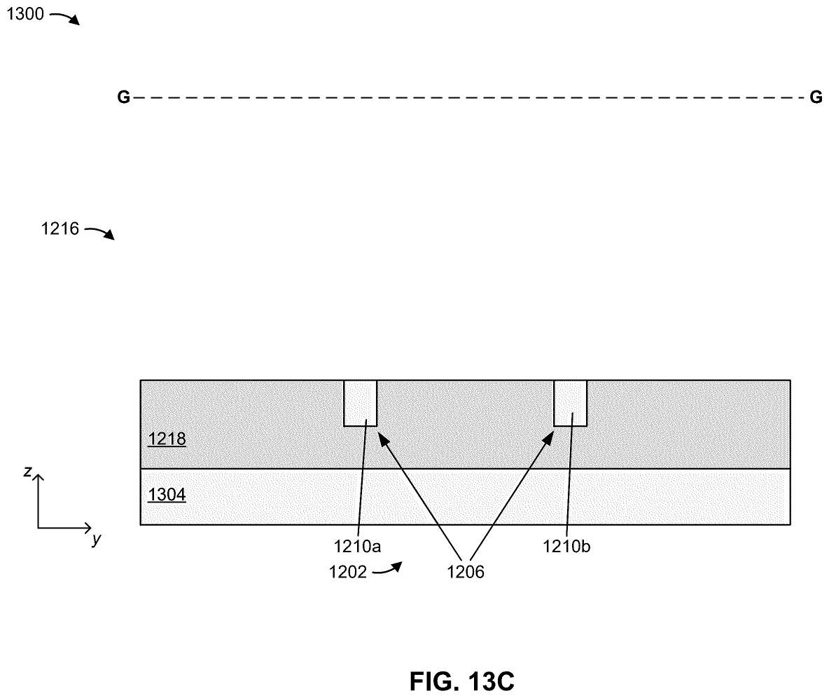

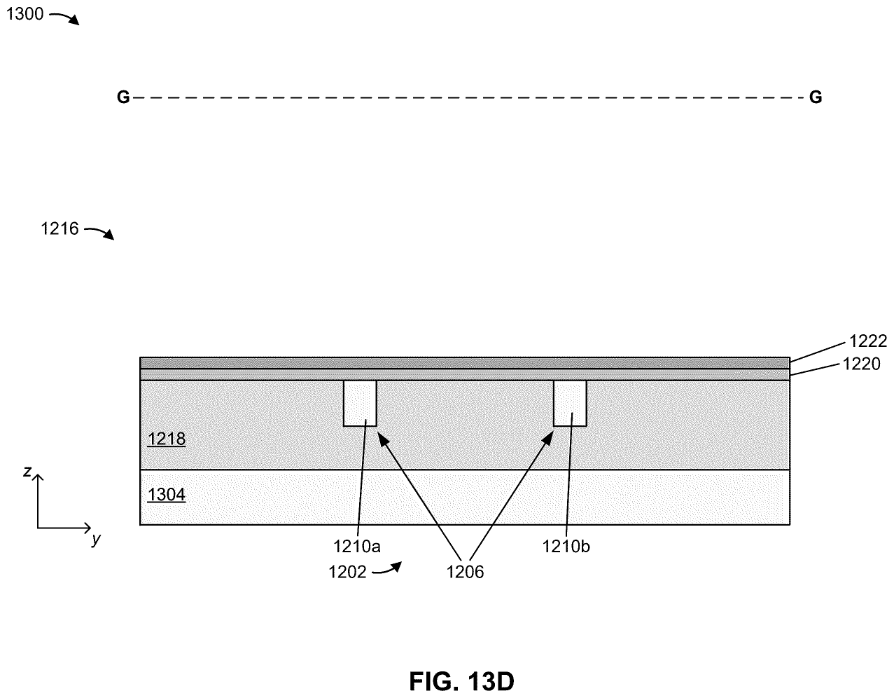

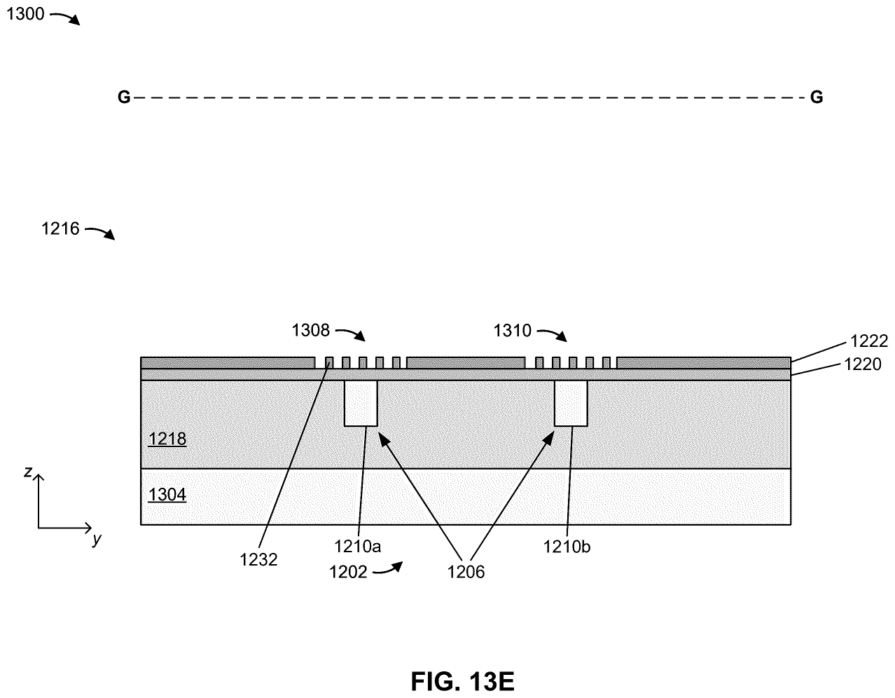

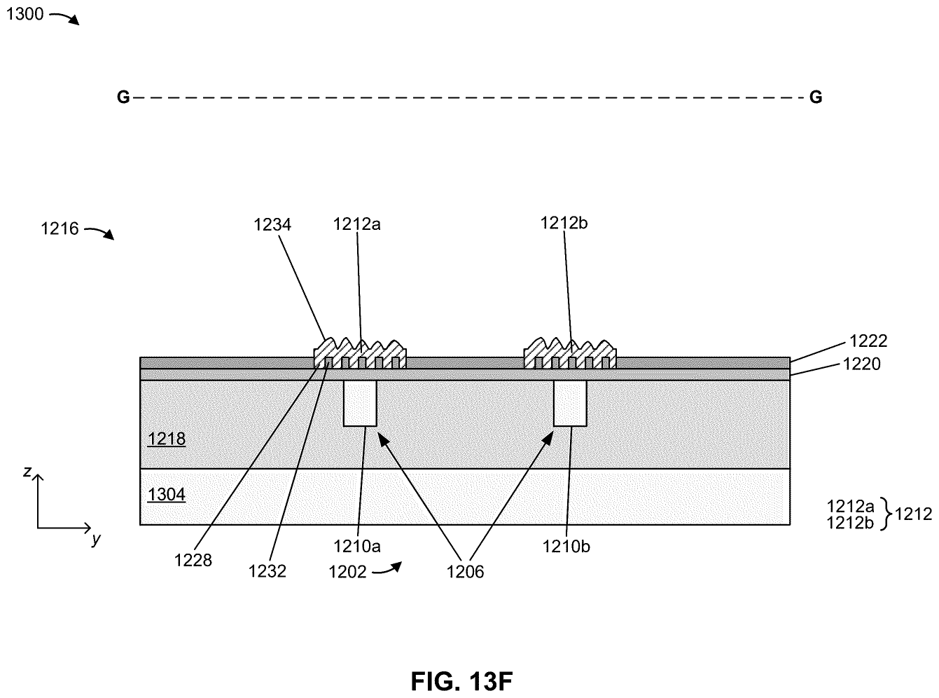

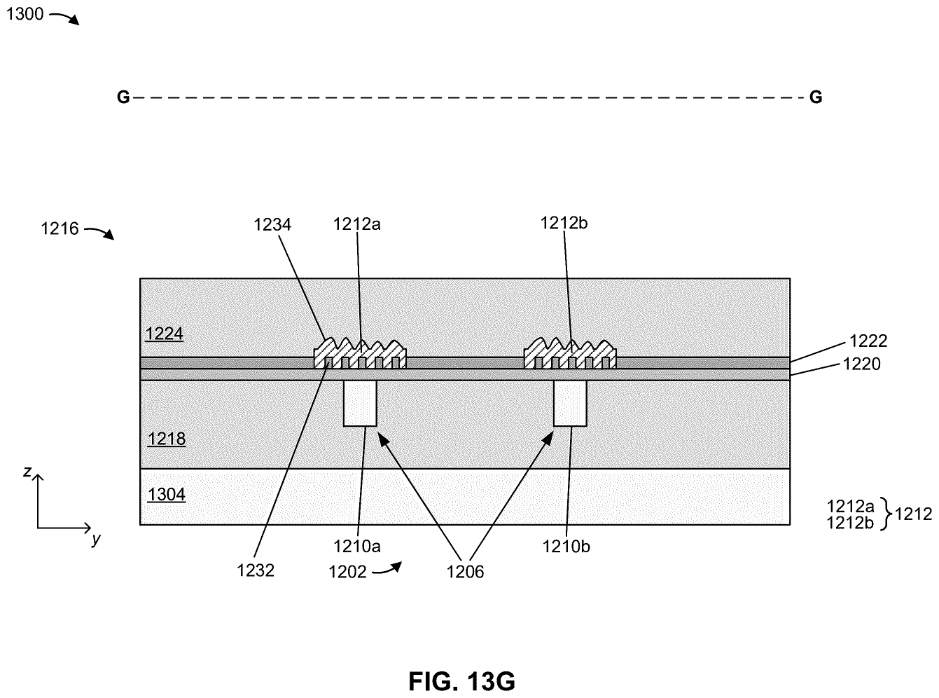

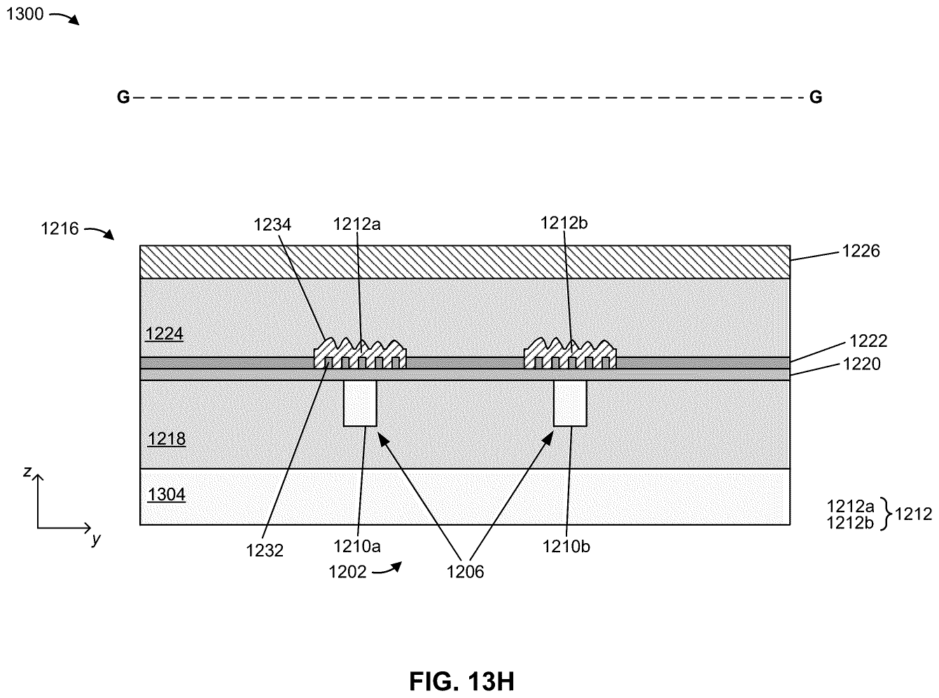

FIGS. 13A-13H are diagrams of an example 1300 of forming the semiconductor photonics device 1216 described herein. In particular, the example 1300 includes an example of forming the photonic integrated circuit 1202 and the associated modulator heater structure 1212 in the semiconductor photonics device 1216. In some implementations, one or more of the semiconductor processing operations described in connection with FIGS. 13A-13H are performed using one or more semiconductor processing tools, such as a deposition tool, an exposure tool, a developer tool, an etch tool, a plating tool, a planarization tool, an ion implantation tool, a wafer/die transport tool, and/or another type of semiconductor processing tool.

Turning to FIG. 13A, a substrate 1302 may be provided. The substrate 1302 may include an SOI substrate that includes a semiconductor substrate 1304, a portion of the dielectric layer 1218 over and/or on the semiconductor substrate 1304, and a semiconductor layer 1306 over and/or on the portion of the dielectric layer 1218. Alternatively, the semiconductor substrate 1304 may be provided as a semiconductor wafer, and a deposition tool may be used to form the portion of the dielectric layer 1218 over and/or on the semiconductor substrate 1304, and may form the semiconductor layer 1306 over and/or on the portion of the dielectric layer 1218.

As shown in FIGS. 13B and 13C, the optical modulator structure 1206 (including the optical modulator segments 1210a and 1210b) may be formed in the semiconductor layer 1306 such that the optical modulator structure 1206 is located above the portion of the dielectric layer 1218. The waveguide structures 1204 and 1208 (not shown in the cross-section view along the line G-G) may also be formed in the semiconductor layer 1306 above the portion of the dielectric layer 1218 along with the optical modulator structure 1206. Additional material of the dielectric layer 1218 may be deposited around the optical modulator structure 1206 (and the waveguide structures 1204 and 1208). Similar process operations and/or techniques described in connection with FIGS. 3B and 3C may be used to form the optical modulator structure 1206 and the additional material of the dielectric layer 1218.

As shown in FIG. 13D, the dielectric layer 1220 may be formed over and/or on the dielectric layer 1218, and the dielectric layer 1222 may be formed over and/or on the dielectric layer 1220, in similar manner as described in connection with FIG. 3F. However, the dielectric layer 1220 is formed over and/or on the optical modulator segments 1210a and 1210b of the optical modulator structure 1206 prior to formation of the heater sections 1212a and 1212b of the modulator heater structure 1212. This is because the dielectric layer 1222 is used to define the shape and/or profile of the heater sections 1212a and 1212b of the modulator heater structure 1212.

As shown in FIGS. 13E and 13F, the heater sections 1212a and 1212b of the modulator heater structure 1212 are formed in the dielectric layer 1222. As shown in FIG. 13E, recesses 1306 are formed through the dielectric layer 1222 above the optical modulator segment 1210a, and recesses 1306 are formed through the dielectric layer 1222 above the optical modulator segment 1210b. Formation of the recesses 1308 and 1310 results in formation of the dielectric spacers 1232 on the dielectric layer 1220.

In some implementations, a pattern in a photoresist layer is used to etch the dielectric layer 1222 to form the recesses 1308 and 1310. In these implementations, a deposition tool may be used to form the photoresist layer on the dielectric layer 1222. An exposure tool may be used to expose the photoresist layer to a radiation source to pattern the photoresist layer. A developer tool may be used to develop and remove portions of the photoresist layer to expose the pattern. An etch tool may be used to etch the dielectric layer 1222 based on the pattern to form the recesses 1308 and 1310. In some implementations, the etch operation includes a plasma etch operation, a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for forming the recesses 1308 and 1310 based on a pattern.

As shown in FIG. 13F, the modulator heater structure 1212 is formed in the recesses 1308 and 1310 such that the heater sections 1212a and 1212b of the modulator heater structure 1212 include segments 1228 in the recesses 1308 and 1310, respectively, that are separated by the dielectric spacers 1232. A deposition tool and/or a plating tool may be used to deposit the heater sections 1212a and 1212b using a CVD technique, a PVD technique, an ALD technique, an electroplating technique, and/or another suitable deposition technique. As indicated above, planarization of the heater sections 1212a and 1212b is omitted, resulting in the heater sections 1212a and 1212b having wavy top surfaces 1234.

As shown in FIG. 13G, the dielectric layer 1224 is formed over and/or on the dielectric layer 1222 such that the dielectric layer 1224 covers the heater sections 1212a and 1212b. The dielectric layer 1224 may be formed in a similar manner as the dielectric layer 224, as described in connection with FIG. 3F.

As shown in FIG. 13H, a metallization layer 1226 may be formed above the dielectric layer 1224. Additionally and/or alternatively, the metallization layer 1226 may be formed in a recess in the dielectric layer 1224. The metallization layer 1226 may be formed in a similar manner as the metallization layer 226 as described above in connection with FIG. 3G.

As indicated above, FIGS. 13A-13H are provided as an example. Other examples may differ from what is described with regard to FIGS. 13A-13H.

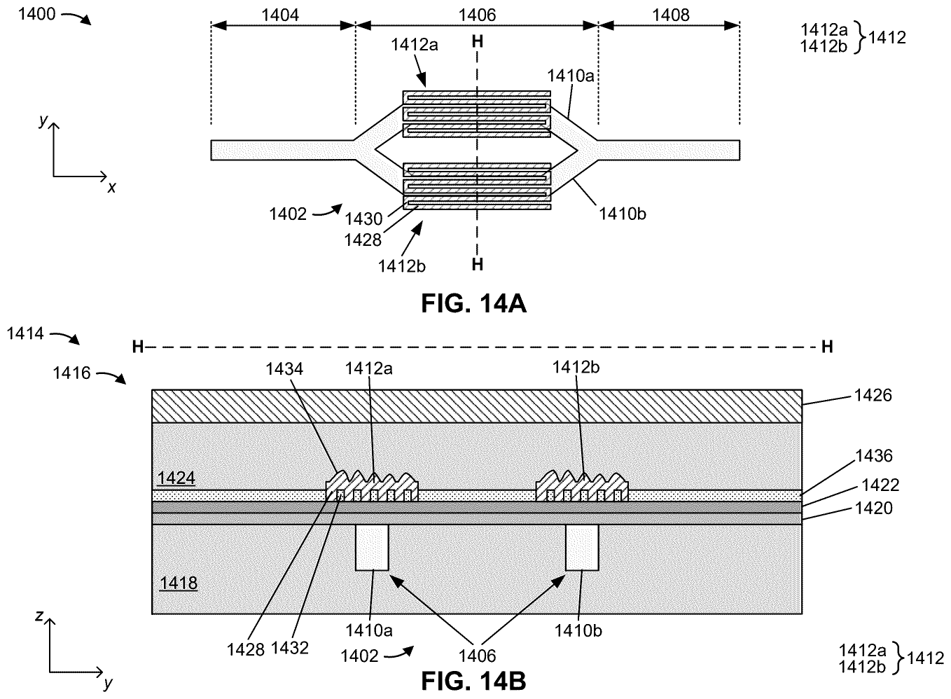

FIGS. 14A and 14B are diagrams of examples of a photonic integrated circuit and an associated semiconductor photonics device in which the photonic integrated circuit may be included. FIG. 14A illustrates a top view of an example 1400 of a photonic integrated circuit 1402. The photonic integrated circuit 1402 is similar to the photonic integrated circuit 102 illustrated in FIG. 1, and includes a waveguide structure 1404, an optical modulator structure 1406, and a waveguide structure 1408. The optical modulator structure 1406 includes optical modulator segments 1410a and 1410b.

As further shown in FIG. 14A, the example 1400 further includes a modulator heater structure 1412 proximate to the optical modulator structure 1406, similar to the example 1200 of the modulator heater structure 1212. Moreover, the modulator heater structure 1412 is structurally similar to the modulator heater structure 1212 and includes heater sections 1412a and 1412b that are located above the optical modulator segments 1410a and 1410b, and that each include a plurality of segments 1428 and one or more connecting segments 1430 that couple the segments 1428 together. The connecting segments 1430 of the heater section 1412a (and of the heater section 1412b) may be located at opposing ends of alternating segments 1428 such that the segments 1428 and the connecting segments 1430 form a repeating pattern in the top view of the modulator heater structure 1412, where the repeating pattern approximately corresponds to a rectangular wave shape. In the example 1400, the segments 1428 are arranged in a direction (e.g., the y-direction) that is approximately perpendicular to the optical modulator segments 1410a and 1410b, and extend in a direction (e.g., the x-direction) that is approximately parallel to the optical modulator segments 1410a and 1410b.

FIG. 14B illustrates an example 1414 of a semiconductor photonics device 1416 in which the photonics integrated circuit 1402 and associated modulator heater structure 1412 may be included. FIG. 14B illustrates a cross-section view along the line H-H in FIG. 14A. In particular, the cross-section view is across the optical modulator segments 1410a and 1410b and across the heater sections 1412a and 1412b in the y-direction. Thus, FIG. 14B illustrates the cross-section view in a y-z plane in the semiconductor photonics device 1416.

As shown in FIG. 14B, the semiconductor photonics device 1416 is similar to the semiconductor photonics device 1216 and includes dielectric layers 1418, 1420, 1422, and/or 1424, and a metallization layer 1426. Moreover, the optical modulator segments 1410a and 1410b are arranged in a similar manner in the semiconductor photonics device 1416 as the optical modulator segments 1210a and 1210b in the semiconductor photonics device 1216, and the heater sections 1412a and 1412b are respectively located above the optical modulator segments 1410a and 1410b similar to the heater sections 1212a and 1212b. The segments 1428 of the heater sections 1412a and 1412b are defined by dielectric spacers 1432.

The heater sections 1412a and 1412b differ from the heater sections 1212a and 1212b in that the heater sections 1412a and 1412b (and the associated dielectric spacers 1432) are located in an oxide patterning layer 1436 above the dielectric layer 1422, as opposed to being located in the dielectric layer 1422. This enables the dielectric layer 1422 to be used as an ESL when defining the dielectric spacers 1432.

The semiconductor photonics device 1416 may be formed by a similar set of semiconductor processing operations as described in FIGS. 13A-13H for the semiconductor photonics device 1216. Instead of forming the dielectric spacers 1432 in the dielectric layer 1422, the oxide patterning layer 1436 may be formed over and/or on the dielectric layer 1422 (e.g., using a deposition tool), and the dielectric spacers 1432 may be formed in the oxide patterning layer 1436. The heater sections 1412a and 1412b may then be formed over and/or on the dielectric spacers 1432 in the oxide patterning layer 1436 such that the segments 1428 and associated connecting segments 1430 are defined by the dielectric spacers 1432. Similar to the heater sections 1212a and 1212b, a planarization may be omitted for the heater sections 1412a and 1412b, resulting in a wavy top surface 1434 for the heater sections 1412a and 1412b.

As indicated above, FIGS. 14A and 14B are provided as examples. Other examples may differ from what is described with regard to FIGS. 14A and 14B.

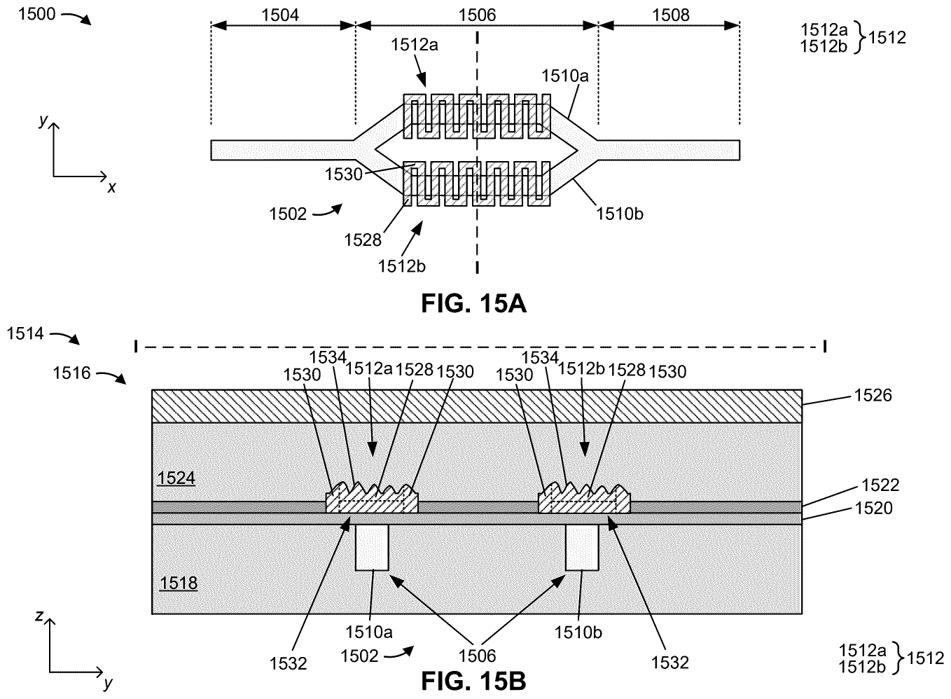

FIGS. 15A-15C are diagrams of examples of a photonic integrated circuit and an associated semiconductor photonics device in which the photonic integrated circuit may be included. FIG. 15A illustrates a top view of an example 1500 of a photonic integrated circuit 1502. The photonic integrated circuit 1502 is similar to the photonic integrated circuit 102 illustrated in FIG. 1, and includes a waveguide structure 1504, an optical modulator structure 1506, and a waveguide structure 1508. The optical modulator structure 1506 includes optical modulator segments 1510a and 1510b.

As further shown in FIG. 15A, the example 1500 further includes a modulator heater structure 1512 proximate to the optical modulator structure 1506, similar to the example 1200 of the modulator heater structure 1212. Moreover, the modulator heater structure 1512 is similar to the modulator heater structure 1212 and includes heater sections 1512a and 1512b that are respectively located above the optical modulator segments 1510a and 1510b, and that each include a plurality of segments 1528 and one or more connecting segments 1530 that couple the segments 1528 together. The connecting segments 1530 of the heater section 1512a (and of the heater section 1512b) may be located at opposing ends of alternating segments 1528 such that the segments 1528 and the connecting segments 1530 form a repeating pattern in the top view of the modulator heater structure 1512, where the repeating pattern approximately corresponds to a rectangular wave shape.

The heater sections 1512a and 1512b differ from the heater sections 1212a and 1212b in that the segments 1528 of each of the heater sections 1512a and 1512b are arranged in a direction (e.g., the x-direction) that is approximately parallel to the optical modulator segments 1510a and 1510b, and extend in a direction (e.g., the y-direction) that is approximately perpendicular to the optical modulator segments 1510a and 1510b. The orientation and/or arrangement of the segments 1528 and connecting segments 1530 may enable efficient manufacturing integration for forming the optical modulator segments 1510a and 1510b along with other conductive structures in the dielectric layer 1524 near the photonic integrated circuit 1502. For example, the segments 1528 being arranged in the x-direction and extending in the y-direction may enable the formation of the optical modulator segments 1510a and 1510b to be better integrated into photomasks/reticles and other process-related equipment and design rules with other conductive structures in the dielectric layer 1524 near the photonic integrated circuit 1502 that are also arranged in the x-direction and extend in the y-direction. Similarly, the segments 1228 (or the segments 1428) being arranged in the y-direction and extending in the x-direction may enable the formation of the optical modulator segments 1210a and 1210b (or the optical modulator segments 1410a and 1410b) to be better integrated into photomasks/reticles and other process-related equipment and design rules with other conductive structures in the dielectric layer 1224 (or in the dielectric layer 1424) near the photonic integrated circuit 1202 (or near the photonic integrated circuit 1402) that are also arranged in the y-direction and extend in the x-direction.

FIG. 15B illustrates an example 1514 of a semiconductor photonics device 1516 in which the photonics integrated circuit 1502 and associated modulator heater structure 1512 may be included. FIG. 15B illustrates a cross-section view along the line I-I in FIG. 15A. In particular, the cross-section view is across the optical modulator segments 1510a and 1510b and across the heater sections 1512a and 1512b in the y-direction. Thus, FIG. 15B illustrates the cross-section view in a y-z plane in the semiconductor photonics device 1516.

As shown in FIG. 15B, the semiconductor photonics device 1516 is similar to the semiconductor photonics device 1216 and includes dielectric layers 1518, 1520, 1522, and/or 1524, and a metallization layer 1526. Moreover, the optical modulator segments 1510a and 1510b are arranged in a similar manner in the semiconductor photonics device 1516 as the optical modulator segments 1210a and 1210b in the semiconductor photonics device 1216, and the heater sections 1512a and 1512b are respectively located above the optical modulator segments 1510a and 1510b similar to the heater sections 1212a and 1212b.

The heater sections 1512a and 1512b differ from the heater sections 1212a and 1212b in that the segments 1528 are orientated approximately 90 degrees relative to the segments 1228. Thus, the cross-section view along the line I-I illustrates an example of a segment 1528 coupled with connecting segments at opposing ends of the segment 1528 for each of the heater sections 1512a and 1512b. The heater sections 1512a and 1512b may extend through the dielectric layer 1522 and into the dielectric layer 1524. The segments 1528 and connecting segments 1530 of the heater sections 1512a and 1512b may be defined by dielectric spacers 1532 (not shown in the cross-section view along the line I-I) formed from the dielectric layer 1522. Alternatively, the heater sections 1512a and 1512b and associated dielectric spacers 1532 may be located in an oxide patterning layer above the dielectric layer 1522, similar to the heater sections 1412a and 1412b in the semiconductor photonics device 1416. The heater sections 1512a and 1512b may have a wavy top surface 1534, similar to the heater sections 1212a and 1212b and/or the heater sections 1412a and 1412b.

FIG. 15C illustrates an example 1536 of a heater section 1512a or 1512b. As shown in FIG. 15C, the segments 1528 of the heater section 1512a (or of the heater section 1512b) may include elongated structures that extend approximately parallel to each other. The connecting segments 1530 of the heater section 1512a (or of the heater section 1512b) may connect ends of adjacent segments 1528 together, and may be arranged in an alternating manner. For example, a first connecting segment 1530 may connect first ends of a first segment 1528 and an adjacent second segment 1528, a second connecting segment 1530 may connect second ends (opposing the first ends) of the second segment 1528 and an adjacent third segment 1528, a third connecting segment 1530 may connect first ends (opposing the second ends) of the third segment 1528 and an adjacent fourth segment 1528, and so on.

As indicated above, FIGS. 15A-15C are provided as examples. Other examples may differ from what is described with regard to FIGS. 15A-15C.

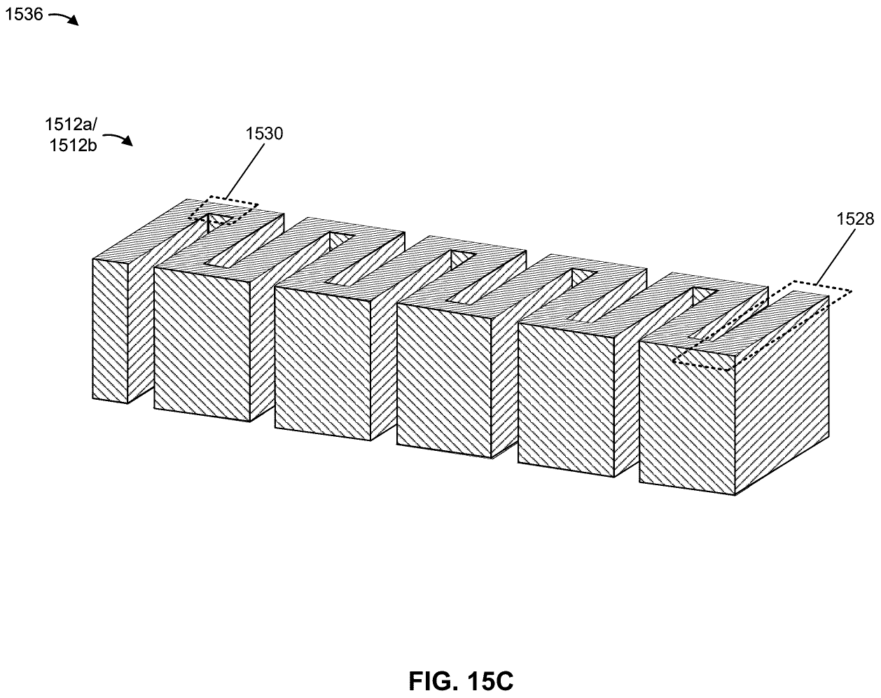

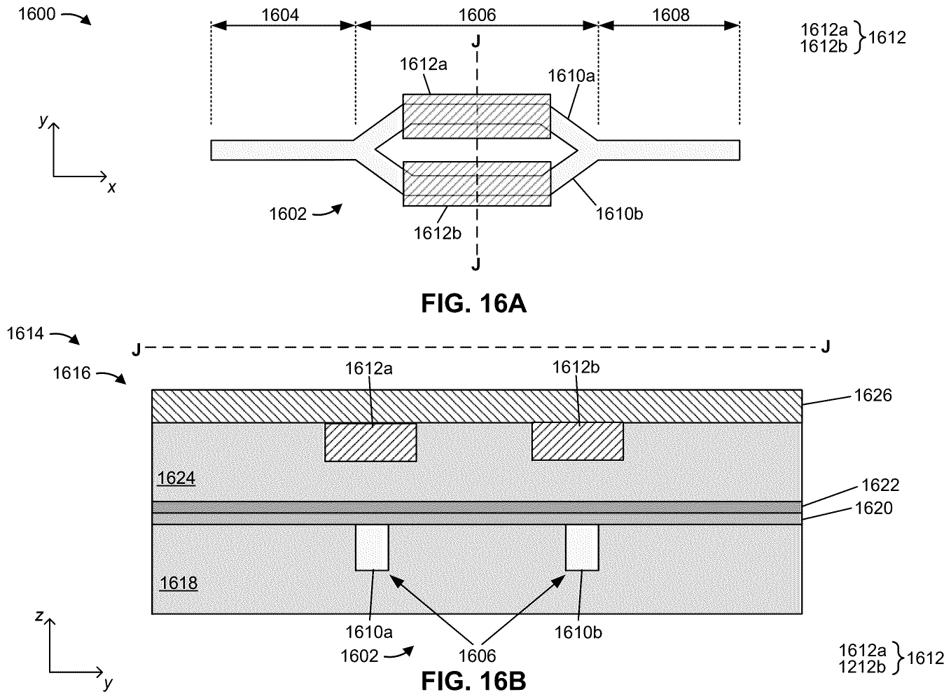

FIGS. 16A and 16B are diagrams of examples of a photonic integrated circuit and an associated semiconductor photonics device in which the photonic integrated circuit may be included. FIG. 16A illustrates a top view of an example 1600 of a photonic integrated circuit 1602. The photonic integrated circuit 1602 is similar to the photonic integrated circuit 102 illustrated in FIG. 1, and includes a waveguide structure 1604, an optical modulator structure 1606, and a waveguide structure 1608. The optical modulator structure 1606 includes optical modulator segments 1610a and 1610b.

As further shown in FIG. 16A, the example 1600 further includes a modulator heater structure 1612 proximate to the optical modulator structure 1606, similar to the example 1200 of the modulator heater structure 1212. Moreover, the modulator heater structure 1612 includes heater sections 1612a and 1612b that are respectively located above the optical modulator segments 1610a and 1610b, similar to the heater sections 1212a and 1212b. In some implementations, the heater sections 1612a and 1612b have an approximately rectangular top view shape or profile and extend in the x-direction over the optical modulator segments 1610a and 1610b, respectively. In some implementations, the heater sections 1612a and/or 1612b have a similar top view shape or profile as the heater sections 1212a and/or 1212b of the modulator heater structure 1212. In some implementations, the heater sections 1612a and/or 1612b have a similar top view shape or profile as the heater sections 1512a and/or 1512b of the modulator heater structure 1512.

The heater sections 1612a and 1612b may each include one or more materials other than metals such as tungsten (W) or copper (Cu). For example, the heater sections 1612a and 1612b may each include one or more materials that have a greater thermal conductivity than tungsten (W) or copper (Cu). This enables the heater sections 1612a and 1612b to be positioned further away from the optical modulator structure 1606 while still providing sufficient heat and achieving sufficient thermal efficiency to stabilize the resonant wavelengths of the optical modulator structure 1606. Examples of such materials include carbon-based materials such as graphene or diamond. Additionally and/or alternatively, the heater sections 1612a and 1612b may each include silicon (Si) doped with one or more types of dopants (e.g., p-type dopants such as boron (B), aluminum (Al), and/or gallium (Ga), among other examples; n-type dopants such as phosphorous (P), arsenic (As), and/or antimony (Sb), among other examples), a metal silicide (e.g., tungsten silicide (WSi), titanium silicide (TiSi)), and/or barrier metals such as tantalum nitride (TaN) and/or titanium nitride (TiN), among other examples.

FIG. 16B illustrates an example 1614 of a semiconductor photonics device 1616 in which the photonics integrated circuit 1602 and associated modulator heater structure 1612 may be included. FIG. 16B illustrates a cross-section view along the line J-J in FIG. 16A. In particular, the cross-section view is across the optical modulator segments 1610a and 1610b and across the heater sections 1612a and 1612b in the y-direction. Thus, FIG. 16B illustrates the cross-section view in a y-z plane in the semiconductor photonics device 1616.

As shown in FIG. 16B, the semiconductor photonics device 1616 is similar to the semiconductor photonics device 1216 and includes dielectric layers 1618, 1620, 1622, and/or 1624, and a metallization layer 1626. Moreover, the optical modulator segments 1610a and 1610b are arranged in a similar manner in the semiconductor photonics device 1616 as the optical modulator segments 1210a and 1210b in the semiconductor photonics device 1216, and the heater sections 1612a and 1612b are respectively located above the optical modulator segments 1610a and 1610b similar to the heater sections 1212a and 1212b.

The heater sections 1612a and 1612b differ from the heater sections 1212a and 1212b in that the heater sections 1612a and 1612b are located in the dielectric layer 1624 above the dielectric layer 1622, as opposed to being located in the dielectric layer 1622. This enables the heater sections 1612a and 1612b to be formed as part of a contact formation process, similar to the processes described in connection with FIGS. 5A-5G and 9A-9H.

As indicated above, FIGS. 16A and 16B are provided as examples. Other examples may differ from what is described with regard to FIGS. 16A and 16B.

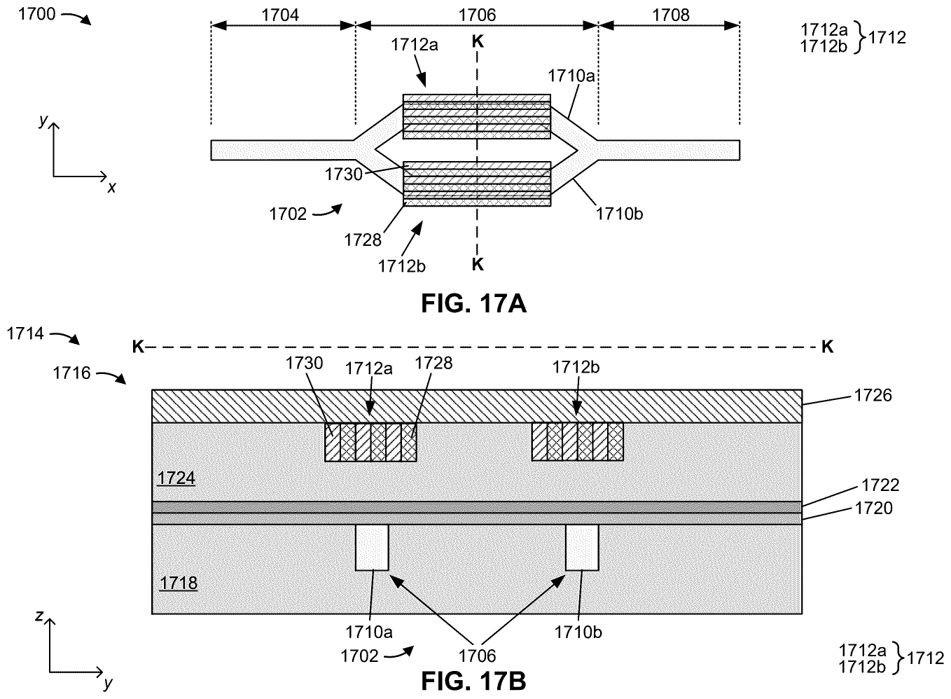

FIGS. 17A and 17B are diagrams of examples of a photonic integrated circuit and an associated semiconductor photonics device in which the photonic integrated circuit may be included. FIG. 17A illustrates a top view of an example 1700 of a photonic integrated circuit 1702. The photonic integrated circuit 1702 is similar to the photonic integrated circuit 102 illustrated in FIG. 1, and includes a waveguide structure 1704, an optical modulator structure 1706, and a waveguide structure 1708. The optical modulator structure 1706 includes optical modulator segments 1710a and 1710b.

As further shown in FIG. 17A, the example 1700 further includes a modulator heater structure 1712 proximate to the optical modulator structure 1706, similar to the example 1600 of the modulator heater structure 1612. Moreover, the modulator heater structure 1712 includes heater sections 1712a and 1712b that are respectively located above the optical modulator segments 1710a and 1710b, similar to the heater sections 1612a and 1612b. In some implementations, the heater sections 1712a and 1712b have an approximately rectangular top view shape or profile and extend in the x-direction over the optical modulator segments 1710a and 1710b, respectively.

The heater sections 1712a and 1712b may differ from the heater sections 1612a and 1612b in that the heater sections 1712a and 1712b each include a plurality of heater segments 1728 and a plurality of heater segments 1730 that are arranged with the heater segments 1728 in an alternating manner. For example, the heater segments 1728 and the heater segments 1730 of the heater section 1712a and/or the heater segments 1728 and the heater segments 1730 of the heater section 1712b may extend in the x-direction and may be arranged in an alternating manner in the y-direction, as shown in the example in FIG. 17A. Alternatively, the heater segments 1728 and the heater segments 1730 of the heater section 1712a and/or the heater segments 1728 and the heater segments 1730 of the heater section 1712b may extend in the y-direction and may be arranged in an alternating manner in the x-direction.

The heater segments 1728 and the heater segments 1730 may each include doped semiconductor materials. For example, heater segments 1730 may each include silicon (Si) doped with one or more n-type dopants such as phosphorous (P), arsenic (As), and/or antimony (Sb), among other examples; and the heater segments 1730 may each include silicon (Si) doped with one or more p-type dopants such as boron (B), aluminum (Al), and/or gallium (Ga), among other examples. As another example, the heater segments 1730 may each include an n-type thermoelectric material such as n-type bismuth telluride (Bi₂Te₃); and the heater segments 1730 may each include a p-type thermoelectric material such as p-type bismuth telluride (Bi₂Te₃). Thus, the heater segments 1730 may be referred to as n-type semiconductor segments and the heater segments 1730 may be referred to as p-type semiconductor segments.

FIG. 17B illustrates an example 1714 of a semiconductor photonics device 1716 in which the photonics integrated circuit 1702 and associated modulator heater structure 1712 may be included. FIG. 17B illustrates a cross-section view along the line K-K in FIG. 17A. In particular, the cross-section view is across the optical modulator segments 1710a and 1710b and across the heater sections 1712a and 1712b in the y-direction. Thus, FIG. 17B illustrates the cross-section view in a y-z plane in the semiconductor photonics device 1716.

As shown in FIG. 17B, the semiconductor photonics device 1716 is similar to the semiconductor photonics device 1616 and includes dielectric layers 1718, 1720, 1722, and/or 1724, and a metallization layer 1726. Moreover, the optical modulator segments 1710a and 1710b are arranged in a similar manner in the semiconductor photonics device 1716 as the optical modulator segments 1610a and 1610b in the semiconductor photonics device 1616, and the heater sections 1712a and 1712b are respectively located above the optical modulator segments 1710a and 1710b similar to the heater sections 1612a and 1612b.

The heater segments 1728 and the heater segments 1730 of the heater section 1712a (and the heater segments 1728 and the heater segments 1730 of the heater section 1712b) may form a thermoelectric cooler that may be used to provide cooling around the modulator heater structure 1712 in the semiconductor photonics device 1716 based on a thermoelectric effect such as the Peltier effect. This enables heat to be radiated from the heater segments 1728 of the modulator heater structure 1712 and toward the optical modulator structure 1706, while enabling excess heat that is radiated away from the optical modulator structure 1706 to be absorbed by the heater segments 1730 of the modulator heater structure 1712. This reduces the likelihood of warpage, cracking, and/or other types of damage to the dielectric layer 1724 and other dielectric layers in the semiconductor photonics device 1716. An electrical input may be applied to the heater segments 1728 to generate the heat. Thus, the heater segments 1728 may be referred to as the hot plate or hot side of the thermoelectric cooler, and the heater segments 1730 may be referred to as the cold plate or cold side of the thermoelectric cooler. In some implementations, the electrical input may be applied to the heater segments 1728 through the top of the semiconductor photonics device 1716 (e.g., through the metallization layer 1726). In some implementations, the electrical input may be applied to the heater segments 1728 through the bottom of the semiconductor photonics device 1716.

As indicated above, FIGS. 17A and 17B are provided as examples. Other examples may differ from what is described with regard to FIGS. 17A and 17B.

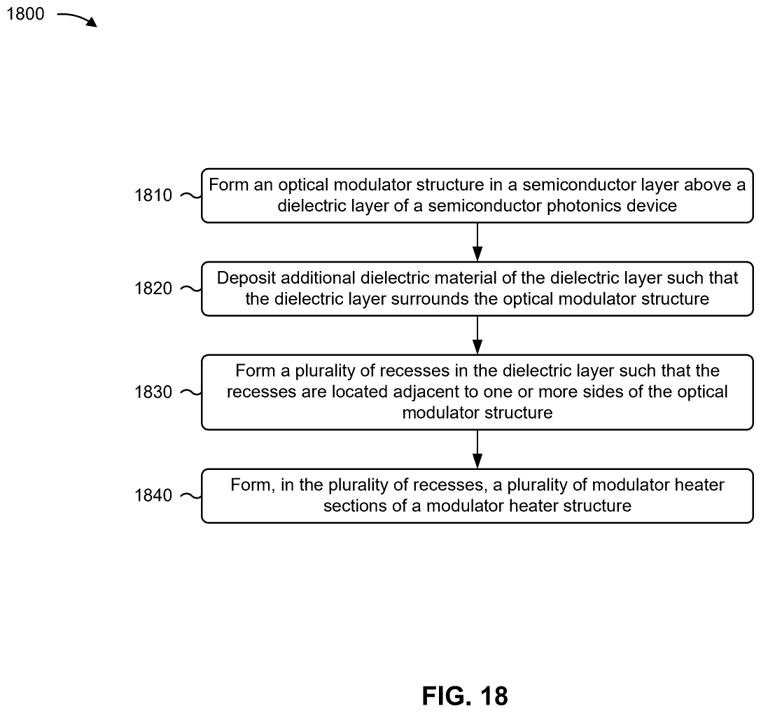

FIG. 18 is a flowchart of an example process 1800 associated with forming a semiconductor photonics devices described herein. In some implementations, one or more process blocks of FIG. 18 are performed using one or more semiconductor processing tools, such as a deposition tool, an exposure tool, a developer tool, an etch tool, a plating tool, a planarization tool, an ion implantation tool, a wafer/die transport tool, and/or another type of semiconductor processing tool.

As shown in FIG. 18, process 1800 may include forming an optical modulator structure in a semiconductor layer above a dielectric layer of a semiconductor photonics device (block 1810). For example, one or more semiconductor processing tools may be used to form an optical modulator structure (e.g., an optical modulator structure 106, 206, 406, 606, 806, 1006, and/or 1106) in a semiconductor layer above a dielectric layer (e.g., a dielectric layer 218, 418, 618, 818, 1018, and/or 1118) of a semiconductor photonics device (e.g., a semiconductor photonics device 216, 416, 616, 816, 1016, and/or 1116), as described herein.

As further shown in FIG. 18, process 1800 may include depositing additional dielectric material of the dielectric layer such that the dielectric layer surrounds the optical modulator structure (block 1820). For example, one or more semiconductor processing tools may be used to deposit additional dielectric material of the dielectric layer such that the dielectric layer surrounds the optical modulator structure, as described herein.

As further shown in FIG. 18, process 1800 may include forming a plurality of recesses in the first dielectric layer such that the recesses are located adjacent to one or more sides of the optical modulator structure (block 1830). For example, one or more semiconductor processing tools may be used to form a plurality of recesses (e.g., recesses 308-312, 508-512, 708-712, 908-912, in the first dielectric layer such that the recesses are located adjacent to one or more sides of the optical modulator structure, as described herein.

As further shown in FIG. 18, process 1800 may include forming, in the plurality of recesses, a plurality of modulator heater sections of a modulator heater structure (block 1840). For example, one or more of the semiconductor processing tools may be used to form, in the plurality of recesses, a plurality of modulator heater sections (e.g., modulator heater sections 212a-212c, 412a-412c, 612a-612c, 812a-812c, 1012a-1012c, and/or 1112a-1112c) of a modulator heater structure (e.g., a modulator heater structure 212, 412, 612, 812, 1012, and/or 1112), as described herein.

Process 1800 may include additional implementations, such as any single implementation or any combination of implementations described below and/or in connection with one or more other processes described elsewhere herein.

In a first implementation, process 1800 includes forming, after forming the plurality of modulator heater sections, one or more additional dielectric layers (e.g., dielectric layers 220-224, 420-424, 620-624, 820-824, 1020-1024, and/or 1120-1124) above the optical modulator structure and above the plurality of modulator heater sections.

In a second implementation, alone or in combination with the first implementation, process 1800 includes forming, prior to forming the plurality of modulator heater sections, one or more additional dielectric layers (e.g., dielectric layers 220-224, 420-424, 620-624, 820-824, 1020-1024, and/or 1120-1124) above the optical modulator structure, where forming the plurality of recesses includes forming the plurality of recesses through the one or more additional dielectric layers, and where forming the plurality of modulator heater sections includes forming the plurality of modulator heater sections in the plurality of recesses such that the plurality of modulator heater sections extend through the one or more additional dielectric layers and into the dielectric layer.

In a third implementation, alone or in combination with one or more of the first and second implementations, process 1800 includes forming one or more connecting heater sections (e.g., connecting heater sections 612d, 812d, 1012d, 1012e, 1112d, and/or 1112e) that extend between and connect to the plurality of modulator heater sections.

Although FIG. 18 shows example blocks of process 1800, in some implementations, process 1800 includes additional blocks, fewer blocks, different blocks, or differently arranged blocks than those depicted in FIG. 18. Additionally, or alternatively, two or more of the blocks of process 1800 may be performed in parallel.

In this way, a semiconductor photonics device includes an optical modulator structure and a modulator heater structure. The position of the modulator heater structure, the shape of the modulator heater structure, and/or the material(s) of the modulator heater structure are selected to increase the heating efficiency of the modulator heater structure.

As described in greater detail above, some implementations described herein provide a semiconductor photonics device. The semiconductor photonics device includes a first dielectric layer. The semiconductor photonics device includes a plurality of second dielectric layers above the first dielectric layer. The semiconductor photonics device includes a semiconductor photonics circuit in the first dielectric layer. The semiconductor photonics circuit includes one or more waveguide structures and an optical modulator structure coupled with the one or more waveguide structures. The semiconductor photonics device includes a modulator heater structure at least partially in the first dielectric layer, where the modulator heater structure includes one or more heater sections laterally adjacent to the optical modulator structure in the first dielectric layer.

As described in greater detail above, some implementations described herein provide a semiconductor photonics device. The semiconductor photonics device includes a first dielectric layer. The semiconductor photonics device includes a plurality of second dielectric layers above the first dielectric layer. The semiconductor photonics device includes a semiconductor photonics circuit in the first dielectric layer. The semiconductor photonics circuit includes one or more waveguide structures and an optical modulator structure coupled with the one or more waveguide structures. The semiconductor photonics device includes a modulator heater structure in one or more of the plurality of second dielectric layers, where the modulator heater structure includes a plurality of heater sections, where each of the plurality of heater sections is located over respective optical modulator segments of the optical modulator structure, and where a heater section, of the plurality of heater sections, includes a plurality of heater segments that are arranged in a first direction and extend in a second direction that is approximately perpendicular to the first direction.

As described in greater detail above, some implementations described herein provide a method. The method includes forming an optical modulator structure in a semiconductor layer above a dielectric layer of a semiconductor photonics device. The method includes depositing additional dielectric material of the dielectric layer such that the dielectric layer surrounds the optical modulator structure. The method includes forming a plurality of recesses in the dielectric layer such that the recesses are located adjacent to one or more sides of the optical modulator structure. The method includes forming, in the plurality of recesses, a plurality of modulator heater sections of a modulator heater structure.

The terms “approximately” and “substantially” can indicate a value of a given quantity that varies within 5% of the value (e.g., ±1%, ±2%, ±3%, ±4%, ±5% of the value). These values are merely examples and are not intended to be limiting. It is to be understood that the terms “approximately” and “substantially” can refer to a percentage of the values of a given quantity in light of this disclosure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor photonics device, comprising:
a first dielectric layer;
a plurality of second dielectric layers above the first dielectric layer;
a semiconductor photonics circuit, in the first dielectric layer, comprising:
one or more waveguide structures; and
an optical modulator structure coupled with the one or more waveguide structures; and
a modulator heater structure at least partially in the first dielectric layer,
wherein the modulator heater structure comprises one or more heater sections laterally adjacent to the optical modulator structure in the first dielectric layer.

2. The semiconductor photonics device of claim 1, wherein top surfaces of the one or more heater sections are approximately co-planar with a top surface of the optical modulator structure.

3. The semiconductor photonics device of claim 1, wherein the one or more heater sections extend into at least a subset of the plurality of second dielectric layers.

4. The semiconductor photonics device of claim 1, wherein the one or more heater sections comprise:
a first heater section adjacent to an outer side of a first segment of the modulator heater structure; and
a second heater section adjacent to an outer side of a second segment of the modulator heater structure.

5. The semiconductor photonics device of claim 4, wherein the one or more heater sections comprise:
a third heater section between the first segment and the second segment.

6. The semiconductor photonics device of claim 4, wherein the one or more heater sections comprise:
a third heater section extending between the first heater section and the second heater section,
wherein the third heater section is located above at least one of the first segment of the modulator heater structure or the second segment of the modulator heater structure.

7. The semiconductor photonics device of claim 4, wherein the first heater section comprises:
a plurality of heater fins that are connected by one or more connecting segments,
wherein the plurality of heater fins and the one or more connecting segments are arranged in an approximate S-shape in a top view of the first heater section.

8. The semiconductor photonics device of claim 1, wherein bottom surfaces of the one or more heater sections are located at a lower vertical position in the first dielectric layer than a bottom surface of the optical modulator structure.

9. A semiconductor photonics device, comprising:
a first dielectric layer;
a plurality of second dielectric layers above the first dielectric layer;
a semiconductor photonics circuit, in the first dielectric layer, comprising:
one or more waveguide structures; and
an optical modulator structure coupled with the one or more waveguide structures; and
a modulator heater structure in one or more of the plurality of second dielectric layers,
wherein the modulator heater structure comprises a plurality of heater sections,
wherein each of the plurality of heater sections is located over respective optical modulator segments of the optical modulator structure, and
wherein a heater section, of the plurality of heater sections, comprises a plurality of heater segments that are arranged in a first direction and extend in a second direction that is approximately perpendicular to the first direction.

10. The semiconductor photonics device of claim 9, wherein the respective optical modulator segments extend in the second direction.

11. The semiconductor photonics device of claim 9, wherein the respective optical modulator segments extend in the first direction.

12. The semiconductor photonics device of claim 9, wherein adjacent ones of the plurality of heater segments are connected by connecting segments of the heater section.

13. The semiconductor photonics device of claim 12, wherein the plurality of heater segments and the connecting segments are arranged in a rectangular wave shape in a top view of the heater section.

14. The semiconductor photonics device of claim 12, wherein a top surface of the heater section has a wavy cross-sectional profile.

15. The semiconductor photonics device of claim 9, wherein the plurality of heater segments comprise:
a plurality of n-type semiconductor segments; and
a plurality of p-type semiconductor segments,
wherein the plurality of n-type semiconductor segments and the plurality of p-type semiconductor segments are arranged in an alternating manner in the first direction.

16. The semiconductor photonics device of claim 9, wherein the plurality of heater segments comprise at least one of:
doped silicon (Si),
tungsten (W),
a silicide, or
graphene.

17. A method, comprising:
forming an optical modulator structure in a semiconductor layer above a dielectric layer of a semiconductor photonics device;
depositing additional dielectric material of the dielectric layer such that the dielectric layer surrounds the optical modulator structure;
forming a plurality of recesses in the dielectric layer such that the recesses are located adjacent to one or more sides of the optical modulator structure; and
forming, in the plurality of recesses, a plurality of modulator heater sections of a modulator heater structure.

18. The method of claim 17, further comprising:
forming, after forming the plurality of modulator heater sections, one or more additional dielectric layers above the optical modulator structure and above the plurality of modulator heater sections.

19. The method of claim 17, further comprising:
forming, prior to forming the plurality of modulator heater sections, one or more additional dielectric layers above the optical modulator structure,
wherein forming the plurality of recesses comprises:
forming the plurality of recesses through the one or more additional dielectric layers, and
wherein forming the plurality of modulator heater sections comprises:
forming the plurality of modulator heater sections in the plurality of recesses such that the plurality of modulator heater sections extend through the one or more additional dielectric layers and into the dielectric layer.

20. The method of claim 17, further comprising:
forming one or more connecting heater sections that extend between and connect to the plurality of modulator heater sections.
